(19) United States
(12) Patent Application Publication
(10) Pub. No.: US 2024/0338885 A1
(43) Pub. Date: Oct. 10, 2024

(54) SYSTEMS AND METHODS FOR RENDERING 3D VOLUMES FROM SCAN DATA ACQUIRED BY COMPUTED TOMOGRAPHY

(71) Applicant: Epica International, Inc., San Clemente, CA (US)

(72) Inventors: Elena Denisova, Florence (IT); Leonardo Bocchi, Florence (IT)

(21) Appl. No.: 18/623,988

(22) Filed: Apr. 1, 2024

Related U.S. Application Data
(60) Provisional application No. 63/493,745, filed on Apr. 1, 2023.
(60) Provisional application No. 63/604,830, filed on Nov. 30, 2023.

(51) Int. Cl. G06T 15/08; G06T 15/00; G06T 15/04; G06T 15/06; G06T 15/20; G06T 15/50

(52) U.S. Cl. CPC G06T 15/08; G06T 15/005; G06T 15/04; G06T 15/06; G06T 15/205; G06T 15/506; G06T 2210/21; G06T 2210/41; G06T 2210/62

(57) ABSTRACT

Rendering three-dimensional (3D) volumes from scan data acquired by computed tomography (CT). A transfer function is applied to a 3D grid of voxels generated from the scan data, each voxel having an associated intensity value, to determine a density value associated with each voxel. A 3D grid of super voxels is generated, each super voxel being formed from a number of adjacent voxels of the 3D grid of voxels, each super voxel having an associated density value. An optimization is performed using the 3D grid of super voxels, based at least in part on a defined super voxel size. A 3D volume is drawn based at least in part on the 3D grid of super voxels and the determined density associated with each super voxel. The super voxel size may be determined based at least in part on a 3D fractal dimension of a 3D volume being rendered.

### CROSS REFERENCE TO RELATED APPLICATIONS

The present application claims priority to U.S. Provisional Patent Application No. 63/493,745, filed Apr. 1, 2023 and U.S. Provisional Patent Application No. 63/604,830, filed Nov. 30, 2023, each of which is hereby incorporated by reference in its entirety.

### BACKGROUND

### Technical Field

The present disclosure generally relates to systems and methods for rendering three-dimensional (3D) volumes from scan data acquired by computed tomography (CT).

### Description of the Related Art

Now that computer hardware performance has achieved a certain level, 3D rendering of biomedical volumes has proven useful for faster comprehension of traumas in areas of high anatomic complexity, for surgical planning, simulation, and training. Also, it improves communication with patients, as they will understand a diagnosis more easily if it is presented in 3D. Therefore, most existing biomedical imaging systems provide different 3D rendering modalities for volume visualization.

Conventional techniques for volume data rendering include maximum-intensity projection (MIP), iso-surface rendering, and direct volume rendering (DVR), but, among other shortcomings, these techniques do not represent the volume data in a photorealistic form. Such a degree of realism is important for clinicians, who may avoid technologies that do not represent the data in a realistic way. Thus, there is a gap between existing technologies and the expectations of clinicians and patients. Furthermore, depending on the selected algorithm, level of details, volume size, and transfer function, the rendering process can be quite slow.

The DVR technique has been enriched with local and global illumination and combined with ambient occlusion and shadowing. However, these modified approaches are not able to produce photo-realistic images, because they are based on a very simplified and unrealistic model. Another proposed version of DVR includes physically based lightning and purportedly allows ray tracing of volumetric data to be done interactively. However, this method is based on single scattering and, consequently, does not produce photorealistic images.

For comparison purposes, a DVR model was enriched with local and global illumination, applying various approaches in an attempt to improve realism (see FIG. 1). It was found that although these techniques can improve realism by introducing deep shadows, they are not suitable for the visualization of biomedical volumes, because they hide information in the shadowed areas, and do not increase the level of detail overall. It is unsurprising, then, that clinicians prefer DVR techniques with local illumination only, as it does not obscure any volume area.

Another conventional technique, Monte Carlo Path Tracing (MCPT), is considered to be suited to iso-surface rendering. However, applied to biomedical volumes, this technique does not typically provide for interaction with the data in real-time.

Thus, 3D rendering of biomedical volumes has become essential for faster comprehension of anatomy, better communication with patients, surgical planning, and training. However, depending on the algorithm, level of detail, volume size, and transfer function, rendering can be quite slow.

### SUMMARY

In one aspect, the disclosed embodiments provide methods, systems, and computer-readable media for rendering three-dimensional (3D) volumes from scan data acquired by computed tomography (CT). The method includes applying a transfer function to a 3D grid of voxels generated from the scan data, each voxel having an associated intensity value, to determine a density value associated with each voxel. The method further includes generating a 3D grid of super voxels, each super voxel being formed from a plurality of adjacent voxels of the 3D grid of voxels, each super voxel having an associated density value. The method further includes performing an optimization using the 3D grid of super voxels, based at least in part on a defined super voxel size. The method further includes drawing a 3D volume based at least in part on the 3D grid of super voxels and the determined density associated with each super voxel.

Embodiments may include one or more of the following features, alone or in combination.

The associated density value of each super voxel may be a maximum value of densities of the plurality of adjacent voxels forming each super voxel. The generating of a 3D grid of super voxels may include performing trilinear interpolation on the 3D grid of voxels. The drawing of a 3D volume based at least in part on the 3D grid of super voxels may include: setting viewport dimensions of a fragment shader to a size of a volume slice (X×Y); and drawing, for each volume slice of a total number of volume slices, Z, a quad that covers the entire viewport. The method may further include repeating the generating of the 3D grid of super voxels whenever the transfer function is changed.

The performing of an optimization may include performing an enhanced empty space skipping optimization, which may include: determining a maximum density value by comparing a first density value sampled at a first position along a ray and a second density value sampled at a second position along the ray, the second position being a distance D from the first position, where D is a first defined step size; setting a step increment to a distance d, where d is a second defined step size, with d<D; determining whether the maximum density value is greater than a defined threshold; returning the density value sampled at the first position, if the maximum density value is greater than the defined threshold, otherwise setting the step increment to the first defined step size D; advancing step-wise along the ray by the step increment; and iteratively repeating the determining a maximum density value, the setting the step increment, the determining whether the maximum density value is greater than a defined threshold, the sampling, and the advancing, until an end of the ray is reached. In embodiments, D=d·s, where s is the defined super voxel size.

The performing of an optimization may include performing an enhanced Maximum Intensity Projection, which may include: (a) determining a local maximum density value by comparing a first density value sampled at a first position along a ray and a second density value sampled a second position along the ray, the second position being a distance D from the first position, where D is a first defined step size; (b) determining whether the local maximum density value is greater than a ray maximum density value and if so: (i) returning the density value sampled at the first position, and (ii) resetting the ray maximum density value to a maximum of a current value of the ray maximum density value compared to the sampled density value at the first position; (c) setting a step increment to a distance d, where d is a second defined step size, with d<D; (d) determining whether the ray maximum density value is greater than or equal to the local maximum density value; (e) setting the step increment to the first defined step size D if the ray maximum density value is greater than or equal to the local maximum density value; (f) advancing step-wise along the ray by the step increment; and iteratively repeating (a)-(f) until an end of the ray is reached. In embodiments, D=d·s, where s is the defined super voxel size.

The performing of an optimization may include performing an enhanced Woodcock Tracking, which may include: setting a current maximum density value equal to a ray maximum density value; (a) determining a local maximum density value by comparing a first density value sampled at a first position along the ray and a second density value sampled at a second position along the ray, the second position being a distance D from the first position, where D is a first defined step size; (b) setting a step increment (l) to the value of the first defined step size D; (c) determining whether the local maximum density value is greater than a defined threshold and if so: (i) returning the density value sampled at the first position, (ii) determining whether the density value sampled at the first position divided by the current maximum density value is greater than a random value and, if so, halting processing of the ray, (iii) setting the step increment (I) to the negative of the log of a random value divided by the local maximum density value, (iv) determining whether the step increment (I) is greater than or equal to the first defined step size D and, if so, setting the step increment (l) to the negative of the log of a random value divided by the ray maximum density value and setting the current maximum density value equal to the ray maximum density value and, if not, setting the current maximum density value equal to the local maximum density value; (d) advancing step-wise along the ray by the step increment (I); and iteratively repeating (a)-(d) until an end of the ray is reached.

In another aspect, the disclosed embodiments provide methods, systems, and computer-readable media for rendering three-dimensional (3D) volumes from scan data acquired by computed tomography (CT). The method includes generating a 3D grid of voxels from CT scan data, each voxel having an associated density value. The method further includes rendering an image by iteratively tracing a plurality of rays originating at a camera position. The rendering includes: (a) determining and storing a color value for each scattering ray in a first target texture based at least in part on a respective existing stored color value and a density value of a respective intersected voxel; (b) determining and storing a position value for each scattering ray in a second target texture based at least in part on a position of the respective intersected voxel in the 3D grid of voxels; (c) determining and storing a scatter direction for each scattering ray in a third target texture based at least in part on the density value of the respective intersected voxel; (d) filling a current frame buffer based at least in part on the first target texture and a previous frame buffer; and (c) displaying the current frame buffer; and iteratively repeating (a)-(c) until a stopping condition is met for all of the rays of the plurality of rays.

Embodiments may include one or more of the following features, alone or in combination.

The method may further include determining an initial origin and direction for each ray of the plurality of rays based at least in part on the camera position. In an iteration, when a scattering ray does not intersect a voxel or a light source, a stopping condition of the scattering ray is met and a zero-length vector may be stored in the third target texture. In an iteration, when a scattering ray intersects a light source, a stopping condition of the scattering ray is met and the respective existing stored color value may be attenuated based at least in part on the color of the intersected light source. In an iteration, when a scattering ray exceeds a scatter number limit, a stopping condition of the scattering ray is met and the respective existing stored color value may be set to zero. The first target texture, the second target texture, and the third target texture, may each be two-dimensional textures of viewport size. The filling of the current frame buffer based at least in part on the first target texture and the previous frame buffer may include summing corresponding values of the first target texture and the previous frame buffer and dividing by the number of iterations. The method may further include repeating the rendering one or more times to progressively display images of improved quality. An initial iteration of direct volume rendering (DVR) may be performed before the rendering and the rendering may be performed one or more times to progressively display images of improved quality.

The determining and storing of a scatter direction for each scattering ray may include: determining whether the density value of the respective intersected voxel is less than a first threshold, greater than a second threshold, or, otherwise, between the first threshold and the second threshold; applying a dielectric phase function, if the density value of the respective intersected voxel is less than the first threshold; applying a metallic phase function, if the density value of the respective intersected voxel is greater than the second threshold; and randomly selecting between: (i) a scatter direction based on at least one light source direction, and (ii) a scatter direction based on voxel scattering, if the density value of the respective intersected voxel is between the first threshold and the second threshold. If the scatter direction based on voxel scattering is selected, the method may further include randomly selecting between surface and volumetric scattering based at least in part on the density value of the respective intersected voxel and a local density gradient.

The rendering of an image may further include: generating a pool of two-dimensional textures; filling the two-dimensional textures with uniformly distributed random numbers; selecting, in each iteration of the iteratively repeating, randomly selecting one or more of the two-dimensional textures from the pool to use in one or more of: advanced Woodcock Tracking, scatter direction determination, and ray direction determination. The method may further include repeating the generating and the filling after a defined number of iterations. The super voxel size may be determined based at least in part on a 3D fractal dimension of a 3D volume being rendered.

The 3D fractal dimension may be determined by: generating a 3D grid of super voxels for each candidate super voxel size, s, in a defined set of super voxel sizes; determining, for each candidate super voxel size, s, a quantity of super voxels having transparency greater than a defined threshold; and performing a linear approximation on a log-log plot of candidate super voxel size versus the quantity of super voxels having transparency greater than the defined threshold, wherein the 3D fractal dimension is given by a slope of the linear approximation.

In another aspect, the disclosed embodiments provide a system for rendering three-dimensional (3D) volumes from scan data acquired by computed tomography (CT), comprising: a graphics processing unit (GPU) in communication with GPU memory; a central processing unit (CPU) in communication with system memory, computer storage, and the GPU. The computer storage stores code which is executed by the CPU and/or the GPU to perform methods described herein. In another aspect, the disclosed embodiments provide a computed tomography (CT) imaging system which includes such a rendering system.

In another aspect, the disclosed embodiments provide a computer-readable medium storing code for rendering three-dimensional (3D) volumes from scan data acquired by computed tomography (CT). The code, when executed by a central processing unit (CPU) and/or a graphics processing unit (GPU) performs methods described herein. In embodiments, the computer-readable medium may be a non-transitory computer-readable medium.

### BRIEF DESCRIPTION OF THE DRAWINGS

FIG. 1 shows an example of a direct volume rendering (DVR) technique for rendering volumes acquired by computed tomography (CT) (left panel), with adjacent voxels combined to form a grid of super voxels (right panel).

FIG. 2 shows an example of an enhanced empty space skipping optimization technique using a 3D grid of super voxels for rendering volumes acquired by computed tomography (CT), the example demonstrating erroneous skips in the absence of step-ahead verification.

FIG. 3 shows the results of optimization methods applied to three different CT acquisitions rendered with the following techniques: DVR, MIP, and Monte Carlo Path Tracing (MCPT) (with volume sampling implemented using advanced Woodcock Tracking); with the data sets: Cat (1a-1d), Hand (2), Knee (3); and the transfer functions: Bone (1a), Skin (1b), Mixed (1c), and Full (1d).

FIG. 4 is a flowchart of a method for rendering three-dimensional (3D) volumes from scan data acquired by computed tomography (CT), in accordance with disclosed embodiments.

FIG. 5 is a flowchart of a method for performing an optimization using the 3D grid of super voxels to provide an enhanced version of empty space skipping optimization.

FIG. 6 is a flowchart of a method 600 for performing an optimization using the 3D grid of super voxels to provide an enhanced version of Maximum Intensity Projection.

FIG. 7 shows an example of rendering biomedical volumetric data using direct volume rendering (DVR) enriched with various types of local and global illumination.

FIGS. 8-10 show examples of rendering biomedical volumetric data using advanced realistic rendering technique (AR²T) for advanced camera settings, hard and soft tissues, and translucency, respectively.

FIGS. 11A-11B depict convergence plots in which vertical lines (2a-4b) indicate the number of iterations needed for convergence (left) and the convergence time in seconds (right).

FIG. 12 shows examples of rendering biomedical volumetric data, in which some of the elements that become considerably more apparent with the AR²T, in comparison to DVR, are highlighted.

FIG. 13 depicts examples of rendering biomedical volumetric data using advanced realistic rendering technique (AR²T) using volumes obtained from a publicly-available dataset with different AR²T settings.

FIG. 14 is a flowchart of a method for rendering three-dimensional (3D) volumes from scan data acquired by computed tomography (CT).

FIG. 15 shows the voxelization of cone-beam computed tomography (CT) volumetric data from imaging a chameleon (left); and a voxel grid rendered using Maximum Intensity Projection (right).

FIG. 16 shows an example of a log/log linear regression to estimate the 3D fractal dimension for a hedgehog cone-beam computed tomography.

FIG. 17 shows a cone-beam computed tomography (CBCT) of a chameleon rendered using AR²T with specific transfer functions for optimal super voxel size evaluation by the 3D fractal dimension.

FIG. 18 is a plot of 3D fractal dimension ranges over a range of super voxel sizes for different types of transfer functions.

FIGS. 19A-C are scatter plots of rendering speed (i.e., the highest measured value) for DVR, AR²T, and MIP, on 3D fractal dimension.

FIGS. 20A-D are plots of optimal super voxel size distribution for DVR (a-b), AR²T (c), and MIP (d).

FIGS. 21A-D are plots of performance loss for DVR (a-b), AR²T (c), and MIP (d), calculated as the difference between the best performance and the performance, achieved using the optimal super voxel size found for the rendering algorithm and the given interval.

FIG. 22 shows the difference between the 3D fractal dimension (3DFD) found using 15 fractals values versus the 3DFD found on-the-fly using just 2 fractals values, for super voxel size 2 and 3-16.

Where considered appropriate, reference numerals may be repeated among the drawings to indicate corresponding or analogous elements. Moreover, some of the blocks depicted in the drawings may be combined into a single function.

### DETAILED DESCRIPTION

Reference will now be made in detail to the embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications, and equivalents that may be included within the scope of the invention as defined by the appended claims. Furthermore, in the following detailed description, numerous specific details are set forth in order to provide a thorough understanding of the present invention. However, it will be understood by those of ordinary skill in the art that the present invention may be practiced without these specific details. In other instances, well-known methods, procedures, components, and circuits have not been described in detail so as not to unnecessarily obscure aspects of the present invention.

Some of the disclosed embodiments relate generally to multiple technique optimization for biomedical volume rendering, and more specifically, to an innovative multi-target (i.e., multiple technique) approach to optimization that uses a voxelization process to produce a voxel grid as a supportive structure. The structure can be quickly constructed and applied to increase the performance gain of a number of different rendering techniques. Among other advantages, such as fast structure construction and traversal, is that it may be applied to widely used rendering techniques, e.g., MIP, DVR, and MCPT (i.e., it is capable of “multi-target” optimization). Thus, the same structure, i.e., the constructed voxel grid, can be used for empty space skipping, improved maximum intensity calculation, and advanced Woodcock tracking, thereby further increasing the performance gain. The performance results, described below, suggest that the disclosed approaches are particularly effective in cases in which different rendering techniques are combined.

Some of the disclosed embodiments relate to three-dimensional (3D) rendering of volumes acquired by means of computed tomography (CT), which can be used to illustrate a diagnosis to a patient, train inexperienced clinicians, and/or facilitate surgery planning. The most realistic visualization can be achieved by the Monte Carlo path tracing (MCPT) rendering technique, which is based on the physical transport of light. However, this technique applied to biomedical volumes has received relatively little attention, because in conventional approaches, it does not provide for interacting with the data in real time.

In disclosed embodiments, an approach to biomedical rendering akin to MCPT is described-referred to herein as Advanced Realistic Rendering Technique (AR²T)—to achieve more realism and increase the level of details in data representation. A practical framework is described which includes different visualization techniques: iso-surface rendering, direct volume rendering (DVR) combined with local and global illumination, maximum intensity projection (MIP), and AR²T. The framework allows for interaction with the data in high quality images for the deterministic algorithms and in lower quality images for the stochastic AR²T. In implementations, a high-quality AR²T image can be generated upon user request, and the quality improves continuously in real time. In some cases, the process is stopped automatically upon convergence of the algorithm or when halted by the user when the desired quality is achieved. The framework enables direct comparison of different rendering algorithms, i.e., utilizing the same view/light position and transfer functions. It therefore can be used by medical experts for immediate one-to-one visual comparison between different data representations to collect feedback about the usefulness of the realistic 3D visualization for clinicians.

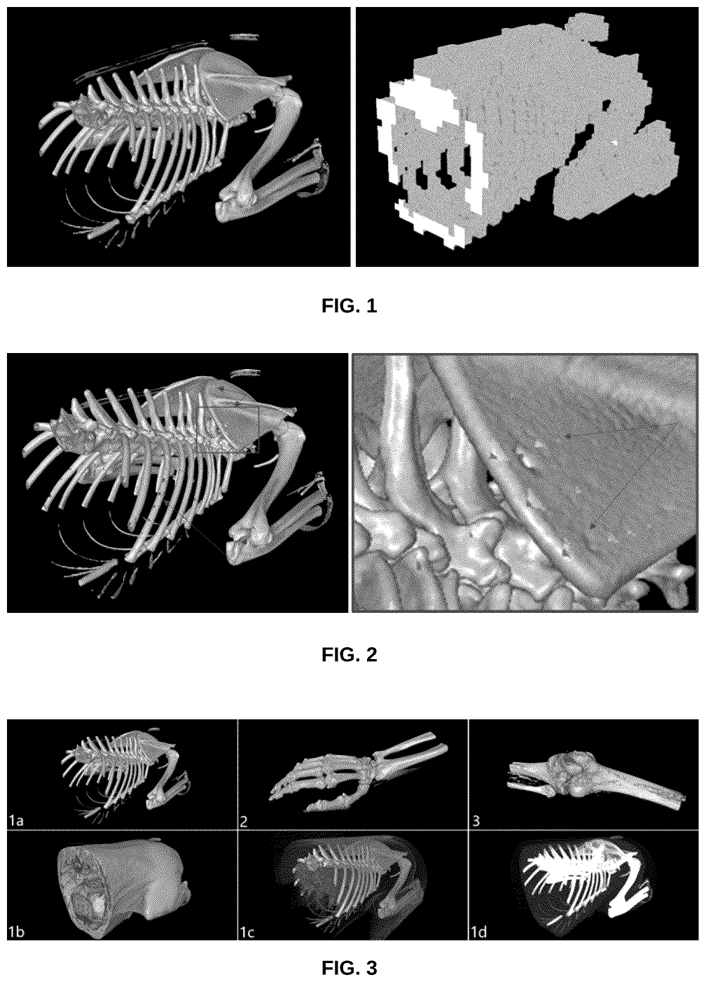

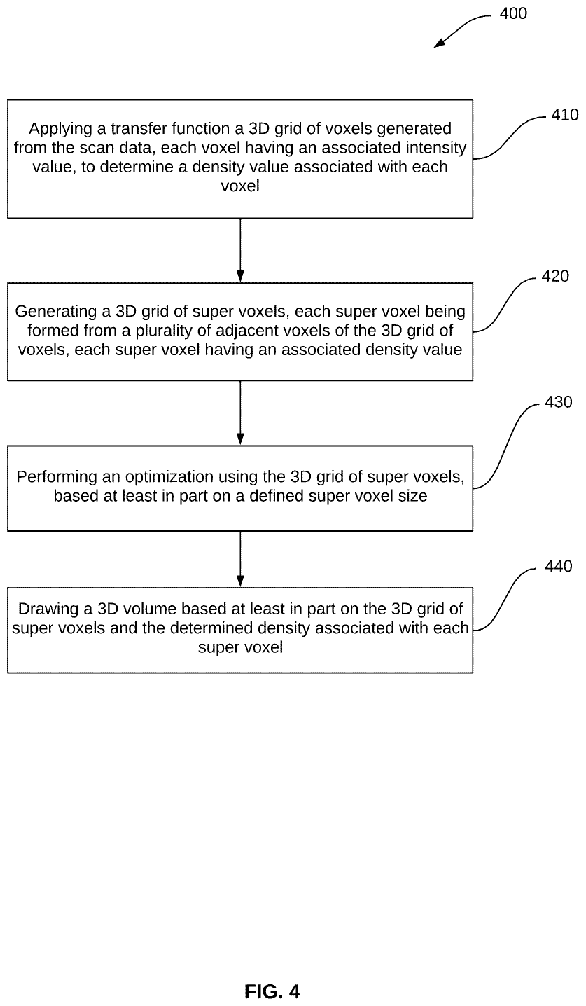

FIG. 4 is a flowchart of a method 400 for rendering three-dimensional (3D) volumes from scan data acquired by computed tomography (CT). The method includes applying a transfer function to a 3D grid of voxels generated from the scan data, each voxel having an associated intensity value, to determine a density value associated with each voxel (410). The method further includes generating a 3D grid of super voxels, each super voxel being formed from a plurality of adjacent voxels of the 3D grid of voxels (420). In other words, the adjacent voxels of an original volume (e.g., the volume defined by the CT scan data) are combined to form a super voxel, which is 3D cube of some fixed size. As shown, e.g., in FIG. 1, the set of super voxels forms a voxel grid, with each super voxel having an associated density value (left panel); and adjacent voxels of the volume defined by the CT scan data being combined to form a super voxel, the set of super voxels forming a voxel grid (right panel). The size of the voxel grid depends on the super voxel size and is equal to (X/s, Y/s, Z/s), where (X, Y, Z) is the size of the original volume and s is the super voxel size. The construction of a voxel grid is called “voxelization.”

An optimization is performed using the 3D grid of super voxels, based at least in part on a defined super voxel size (440). The voxel grid may be applied to rendering optimization, e.g., maximum-intensity projection (MIP), direct volume rendering (DVR), and Monte Carlo path tracing (MCPT), for empty space skipping and advanced Woodcock Tracking, thereby implementing enhanced versions of the rendering optimization techniques. The method further includes drawing a 3D volume based at least in part on the 3D grid of super voxels and the determined density associated with each super voxel (450). In disclosed embodiments, the associated density value of each super voxel is a maximum value of densities of the adjacent voxels forming each super voxel. Generating the 3D grid of super voxels may include performing trilinear interpolation on the 3D grid of voxels.

In embodiments, a super voxel is constructed by finding the maximum value of the transparency (or density) of all voxels that fall into the super voxel. Note that every time the transfer function changes, the voxel grid should be reconstructed. Therefore, it is important to construct the voxel grid fast. In implementations, the voxel grid construction is delegated to OpenGL fragment shader stage. OpenGL (Open Graphics Library) is a widely-used, cross-platform graphics library and application programming interface (API) for rendering 2D and 3D graphics. It provides a set of functions for creating and manipulating visual elements, such as geometry, textures, and shaders, and for managing the graphics pipeline.

In one example, the viewport dimensions are set to the size of a volume slice X×Y. A quad is drawn that covers the entire viewport. The drawing is repeated Z times, where Z is the number of slices in the volume, by scrolling from 0 to (Z−1) to envelop the entire volume. To construct the voxel grid, OpenGL imageAtomicMax is used, which is a function that overwrites a stored value if it is less than a given value (see Algorithm 1). The voxel density is calculated as follows: first, the trilinear interpolation is applied to the samples from the original volume to get the voxel intensity; then, the voxel intensity is mapped on the current transfer function. Given the maximum volume dimension N=max (X, Y, Z) and super voxel size s, the operation complexity of the voxelization process can be estimated by O(N³). The memory consumption is estimated by

$$O ( {( \frac{N}{\text{?}} )}^{3} ) .$$

$$\text{?} \text{indicates text missing or illegible when filed}$$

Algorithm 1 is a pseudocode example for constructing a 3D grid of super voxels:

Algorithm 1 Voxelization

| | |
|---|---|
| viewport ← (X,Y) | [symbol] C++ |
| s ← SuperVoxelSize | |
| i ← 0 | |
| glUniform8f(dimsLocation, X, Y, Z) | |
| glUniform1i(sLocation, s) | |
| while i ≠ Z do | |
| glUniform 1i(iLocation, i) | |
| glDrawElements(...) | |
| i ← i + l | |
| end while | |
| volumeCoords ← (gl_FragCoords.xy, i)/(X,Y.Z) | [symbol] GLSL |
| density ← Density(volumeCoords) | |
| voxelGridCoords ← (gl_FragCoords_xy,i)/(s,s,s) | |
| imageAtomicMax(VoxelGrid, voxelGridCoords, density) | |

Empty space skipping is an optimization technique used in rendering 3D volumes acquired by computed tomography (CT) or other volumetric imaging modalities. In volume rendering, a significant portion of the volume data may correspond to regions with low or no relevant information which do not contribute to the final rendered image. Empty space skipping aims to accelerate the rendering process by identifying and skipping these regions, reducing the computational overhead associated with ray casting, sampling, and integration. Empty space skipping requires an additional data structure to efficiently represent the empty or non-contributing regions within the volume, such as the disclosed 3D grid of super voxels. The regions within the 3D volume that correspond to empty space or areas with low opacity that do not contribute significantly to the final rendered image. This can be done using a thresholding technique based on the intensity values or opacity values derived from the transfer function.

In implementations, a voxel grid (i.e., a 3D grid of super voxels) may be used to perform an enhanced empty space skipping optimization. Rays are cast from the camera's position through the pixels and into the 3D volume, as in a standard rendering process. However, before sampling and volume integration, the data structure representing the empty regions is queried to determine if the current ray segment intersects any non-empty space. If the ray segment lies entirely within an empty region, it can be skipped, avoiding unnecessary sampling and integration computations. If the ray segment intersects a non-empty region, the standard rendering process is applied, starting from the intersection point.

Thus, an empty space skipping optimization is based on the idea that the voxels whose density is zero (or lower than some threshold) usually do not contribute to the result of any volume rendering technique and therefore should not be sampled. In one approach, given the ray that traverses the volume in direction rayDir starting from the intersection point rayStart to the exit point rayEnd, the naive volume sampling along the ray can be achieved by advancing with some fixed small step d. In implementations, the 3D grid of super voxels discussed above can be used for empty space skipping. If the density of the super voxel is less than some threshold, then all voxels that contributed to the construction of this super voxel in the voxelization stage can be skipped without sampling. Thus, rather than advancing with small step d, it is possible to advance with step D=d·s, where s is the super voxel size. This is illustrated by Algorithm 2 (below). In embodiments, to advance with the step D safely, the super voxel density can be verified one D-step ahead. Otherwise, the border voxels could be erroneously skipped (see FIG. 2).

Algorithm 2 is a pseudocode example for performing an optimization using the 3D grid of super voxels to provide an enhanced version of empty space skipping optimization:

Algorithm 2 Empty Space Skipping

| | |
|---|---|
| rayLen ← length(rayEnd − rayStart) | [symbol] GLSL |
| threshold ← 10⁻⁵ | |
| pas ← rayStart | |
| while rayLen ≥ 0 do | |
| α ← max(SuperDensity(pos), SuperDensity(pos + | |
| D · rayDir)) | |
| step ← d | |
| if a > threshold then | |
| Sample(pos) | |
| else | |
| step ← D | |
| end if | |
| pos ← pos + step · rayDir | |
| rayLen ← rayLen − step | |
| end while | |

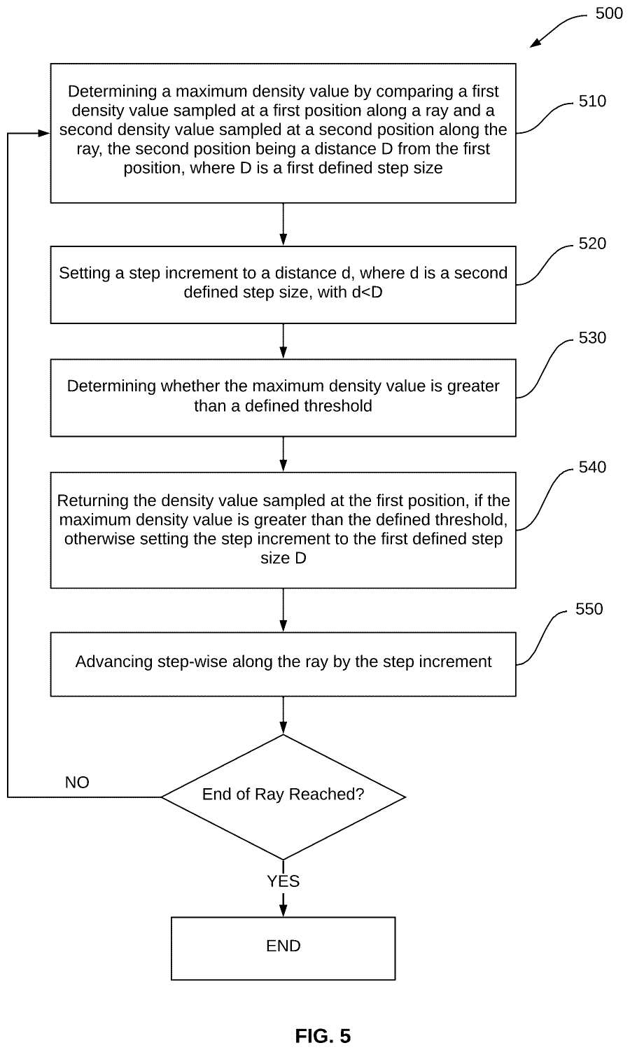

FIG. 5 is a flowchart of a method 500 for performing an optimization using the 3D grid of super voxels to provide an enhanced version of empty space skipping optimization. A maximum density value is determined by comparing a first density value sampled at a first position along a ray and a second density value sampled at a second position along the ray, the second position being a distance D from the first position, where D is a first defined step size (510). A step increment is set to a distance d, where d is a second defined step size, with d<D (520). The method further includes determining whether the maximum density value is greater than a defined threshold (530). The method further includes returning the density value sampled at the first position, if the maximum density value is greater than the defined threshold, otherwise setting the step increment to the first defined step size D (540). The method further includes advancing step-wise along the ray by the step increment (550). The method further includes iteratively repeating the determining a maximum density value (510), the setting of the step increment (520), the determining whether the maximum density value is greater than a defined threshold (530), the returning of the density value sampled at the first position (540), and the advancing (550), until an end of the ray is reached. In embodiments, D=d·s, where s is the defined super voxel size.

Maximum Intensity Projection (MIP) is a volume rendering technique commonly used to visualize 3D data acquired by computed tomography (CT) scans. It is particularly useful for highlighting high-intensity structures within the volume, such as blood vessels, bone, or areas of contrast agent accumulation. MIP simplifies the 3D volume data into a 2D image by projecting the maximum intensity value along a specified direction.

For each pixel in the output image, a ray is cast from the specified projection direction through the 3D volume. The ray passes through multiple voxels along its path. For each ray, the maximum intensity value encountered along its path through the volume is determined. This is done by comparing the intensity values of all voxels along the ray, and selecting the highest value. The maximum intensity value for each ray is assigned to the corresponding pixel in the output 2D image. This process is repeated for all pixels in the image.

In disclosed embodiments, an optimization can be performed using the 3D grid of super voxels to provide an enhanced version of maximum intensity optimization, in a manner similar to the enhanced empty space skipping discussed above. One difference is that the density of the super voxel is compared to the current maximum intensity value instead of a constant threshold. An advantage with respect to the empty space skipping algorithm is that even if the super voxel density is less than the current maximum intensity, and sampling is necessary, a super voxel can still can be skipped if the sampling result equals the entire super voxel density (see Algorithm 3).

Algorithm 3 is a pseudocode example of performing an optimization using the 3D grid of super voxels to provide an enhanced version of Maximum Intensity Projection:

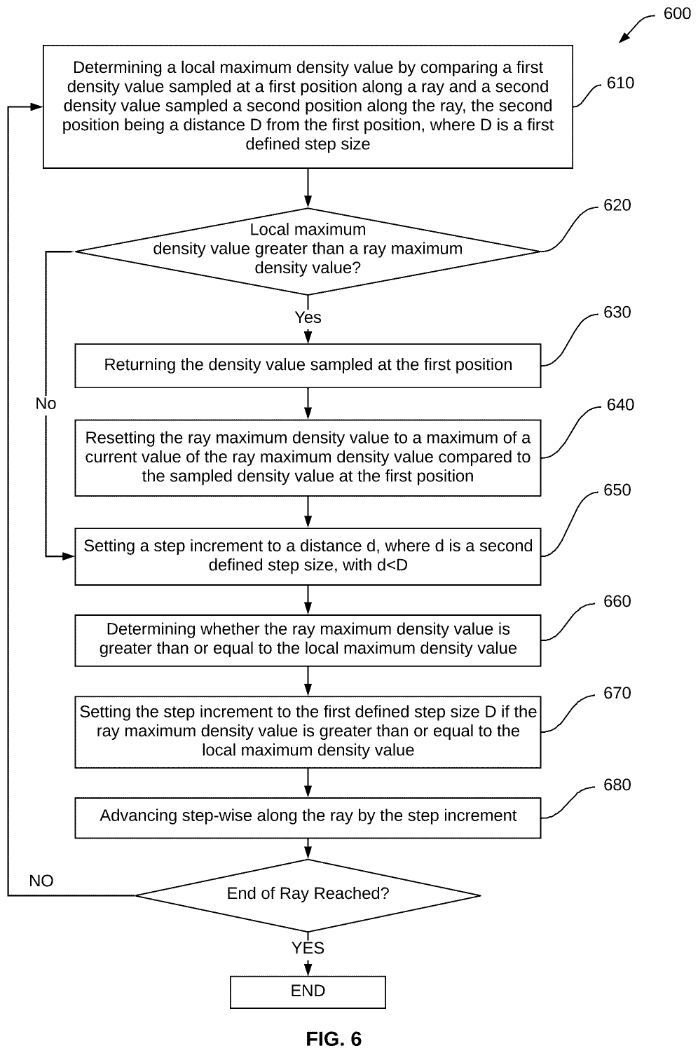

FIG. 6 is a flowchart of a method 600 for performing an optimization using the 3D grid of super voxels to provide an enhanced version of Maximum Intensity Projection. The method includes determining a local maximum density value by comparing a first density value sampled at a first position along a ray and a second density value sampled at a second position along the ray, the second position being a distance D from the first position, where D is a first defined step size (610). The method further includes determining whether the local maximum density value is greater than a ray maximum density value (620). If so, then the density value sampled at the first position is returned (630), and the ray maximum density value is reset to a maximum of a current value of the ray maximum density value compared to the sampled density value at the first position (640). A step increment is set to a distance d, where d is a second defined step size, with d<D (650). The method further includes determining whether the ray maximum density value is greater than or equal to the local maximum density value (660). The step increment is set to the first defined step size D if the ray maximum density value is greater than or equal to the local maximum density value (670). The method further includes advancing step-wise along the ray by the step increment (680). These steps (610-680) are iteratively repeated until the end of the ray is reached. In embodiments, D=d·s, where s is the defined super voxel size.

Algorithm 3 Maximum Intensity Calculation

| | |
|---|---|
| rayLen ← lenght(rayEnd − rayStart) | [symbol] GLSL |
| αₘₐₓ ← 0 | |
| threshold ← 1 − 10⁻⁵ | |
| pos ← rayStart | |
| while rayLen ≥ 0 do | |
| α ← max(SuperDensity(pos), SuperDensity(pos + | |
| D · rayDir)) | |
| if α > αₘₐₓ then | |
| i ← Density(pos) | |
| αₘₐₓ ← max(αₘₐₓ, i) | |
| if αₘₐₓ > threshold then | |
| break | |
| end if | |
| end if | |
| step ← d | |
| if αₘₐₓ ≥ α then | |
| step ← D | |
| end if | |
| pos ← pos + step · rayDir | |
| rayLen ← rayLen − step | |
| end while | |

Woodcock Tracking, also known as Woodcock's delta tracking or null-collision method, is a sampling technique and, specifically, an optimization technique primarily used in Monte Carlo-type simulations. During the simulation, rays are allowed to traverse the voxel grid until a “null-collision” or “virtual event” occurs, which is a random event with a probability determined by comparing the local optical properties of the actual medium with the maximum optical properties of an imaginary homogeneous medium. When a null-collision occurs, the simulation checks the local optical properties of the actual medium at position on the ray. If the local properties are lower than the maximum properties of the imaginary medium, the null-collision is ignored, and the ray continues its trajectory without any interaction. If the local properties are equal or similar to the maximum properties, the ray interacts with the medium, as in the standard Monte Carlo simulation. The information obtained from the Monte Carlo simulation, such as the accumulated radiance along sampled paths, is used to compute the final color and intensity values for each pixel in the rendered image.

Conversely from the Riemann sum, Woodcock tracking is unbiased and does not require the sampling of every discrete point along the traversing ray. Instead of choosing the transmittance value, the distance where this value could be achieved is chosen depending on the maximum density αₘₐₓ among the entire volume. The voxel on the probe distance is accepted with probability

$$\frac{\text{?}}{{α ( pos )}_{max}} ,$$

$$\text{?} \text{indicates text missing or illegible when filed}$$

where α is the density of the probe voxel. If the voxel is rejected, the process repeats from the rejected point until some voxel is accepted or the end of the ray is achieved. However, if the local volume density is much smaller than the maximum volume density, the gain of Woodcock Tracking smooths out, which means that the probability of accepting the voxels from low-density regions becomes very small, and the process should be repeated until the high-density region is hit. To resolve this issue, an advanced Woodcock Tracking is disclosed.

Advanced Woodcock Tracking involves dividing the original volume with large density variation on the sub-volumes with small local density variation. The probe distances are then chosen depending on the maximum local density, and the probability of the voxel acceptance becomes

$$\frac{\text{?}}{{α ( pos )}_{max}} ,$$

$$\text{?} \text{indicates text missing or illegible when filed}$$

where α(pos) max is the density of the super voxel that corresponds to the probe voxel. Thus, the voxel grid, constructed previously, can be used to implement the advanced Woodcock Tracking (see Algorithm 4). Note, that if a super voxel has a very small maximum density, the distance l generated on this super voxel will be very large

$$( l = - \frac{log ( rand )}{{α ( pos )}_{max}} ) .$$

Thus, the distance should be adjusted using maximum density alphaₘₐₓ, otherwise, there is a risk of jumping too far away from the current voxel and skipping voxels with significant density. This may lead to a situation represented by FIG. 2.

Algorithm 4 is a pseudocode example of a method for performing an optimization using the 3D grid of super voxels to provide an enhanced version of Woodcock Tracking.

Algorithm 4 Advanced Woodcock Tracking

```
rayLen ← length(rayEnd − rayStart) [symbol]
← [symbol]
$\text{?} ← \text{?} \frac{\text{?}}{\text{?}}$ [symbol]
← [symbol]
threshold ← 10⁻⁵
pos ← rayStart
while rayLen ≥ 0 do
  α ← max(SuperDensity(pos).SuperDensity(pos + D · rayDir))
  l ← D
  if α > threshold then
    i ← Density(pos)
    $if \frac{\text{?}}{\text{?}} > \text{?} then$
      break
    end if
    l ← [symbol]
    if l ≥ D then
      $\text{?} ← \text{?} \frac{\text{?}}{\text{?}}$ [symbol]
      ← [symbol]
    else [symbol]
      ← α
    end if
  end if
  pos ← pos + l · rayDir
  rayLen ← rayLen − 1
end while [symbol]
indicates data missing or illegible when filed
```

An embodiment of a method for performing an optimization using the 3D grid of super voxels to provide an enhanced version of Woodcock Tracking may be described as follows. The method includes setting a current maximum density value equal to a ray maximum density value (X410). A local maximum density value is determined by comparing a first density value sampled at a first position along the ray and a second density value sampled at a second position along the ray, the second position being a distance D from the first position, where D is a first defined step size (X420). A step increment/is set to the value of the first defined step size D (X425). The method further incudes determining whether the local maximum density value is greater than a defined threshold. If so, the method includes: (i) returns the density value sampled at the first position (X430), (ii) determining whether the density value sampled at the first position divided by the current maximum density value is greater than a random value and, if so, halting processing of the ray (X435), (iii) setting the step increment/to the negative of the log of a random value divided by the local maximum density value (X440), and (iv) determining whether the step increment/is greater than or equal to the first defined step size D (X445) and, if so, setting the step increment/to the negative of the log of a random value divided by the ray maximum density value (X450) and setting the current maximum density value equal to the ray maximum density value (X455) and, if not, setting the current maximum density value equal to the local maximum density value (X460). The method further includes advancing step-wise along the ray by the step increment/(X465). The method further includes iteratively repeating (X420)-(X465) until an end of the ray is reached (X470).

The following discussion illustrates the results of the optimization method applied to three different CT acquisitions rendered with the following techniques: DVR (empty space skipping according to Alg.2), MIP (according to Alg.3), and MonteCarlo Path Tracing (MCPT) (with volume sampling implemented using advanced Woodcock Tracking as described in Alg.4). Three typical transfer functions were applied for all of the acquisitions (see FIG. 3) and the rendering speed measurement are presented in Table 1. In FIG. 3, the data sets were: Cat (1a-1d), Hand (2), Knee (3); the Transfer Functions were: Bone (1a), Skin (1b), Mixed (1c), and Full (1d). It should be noted that in these results, bone, skin, mixed are applied on DVR and MCPT, while Full is applied only for MIP.

According to Table 1, the disclosed voxelization technique increased the performance up to 9 times for DVR. The speed-up highly depends on the transfer function. The transfer functions that zero out a larger volume area lead to major performance gain (see Bone). In the case of MCPT, the 5× speed-up is stable and does not depend on the transfer function. It is an expected situation, and it shows that the advanced Woodcock Tracking resolved the issue, connected to large density variation introduced by some transfer functions (see Mixed). The MIP speed-up is also stable and is about 50% of the original speed. The minor MIP speed-up can be explained by the early break when alphaₘₐₓ becomes greater than threshold (see Alg.3). The results of the research performed indicate that the usage of the disclosed methods is especially advantageous when different rendering techniques are combined.

The images, presented in this paper, were generated from the post mortem (Hand, Knee), or animals (Cat) CBCT (Cone-Beam Computed Tomography) acquisitions, made using the HDVI (High-Definition Volumetric Imaging) CT Medical Imaging Platform.

TABLE 1
All data sets are encoded in 16-bit format. The speed for DVR, MCPT and MIP is in frames per second.
Voxelization is measured in milliseconds. Super voxel size is 4. All rendered on Intel(R) Core(TM)
i5-7600K CPU @ 3.80 GHz with NVIDIA Geforce GTX 1060 4 Gb, viewport size 1727 × 822.

| | Bone | | | Skin | | | Mixed | | | Full | | |
|---|---|---|---|---|---|---|---|---|---|---|---|---|
| Cat 803 × 803 × 598 | | | | | | | | | | | | |
| DVR | 21.3 | 3.0 | 7.1x | 20.4 | 4.4 | 4.6x | 7.4 | 2.8 | 2.6x | | | |
| MCPT | 13.3 | 3.1 | 4.3x | 14.3 | 3.5 | 4.1x | 4.1 | 1.2 | 3.4x | | | |
| MIP | | | | | | | | | | 27.0 | 19.2 | 1.4x |
| Voxelization | 303 | | | 309 | | | 322 | | | 306 | | |
| Hand 707 × 704 × 1336 | | | | | | | | | | | | |
| DVR | 20.0 | 2.2 | 9.1x | 22.2 | 2.5 | 8.9x | 10.4 | 2.1 | 5.0x | | | |
| MCPT | 12.5 | 2.5 | 5.0x | 15.2 | 2.7 | 5.6x | 6.4 | 1.2 | 5.3x | | | |
| MIP | | | | | | | | | | 23.8 | 14.5 | 1.6x |
| Voxelization | 539 | | | 546 | | | 548 | | | 648 | | |
| Knee 704 × 703 × 1327 | | | | | | | | | | | | |
| DVR | 21.3 | 2.4 | 8.9x | 19.3 | 4.1 | 4.8x | 6.5 | 2.1 | 3.1x | | | |
| MCPT | 14.5 | 2.0 | 5.0x | 10.6 | 2.7 | 3.9x | 3.5 | 0.8 | 4.4x | | | |
| MIP | | | | | | | | | | 19.6 | 14.7 | 1.3x |

| | | | | |
|---|---|---|---|---|
| Voxelization | 534 | 576 | 600 | 627 |

In disclosed embodiments, different visualization techniques are described, including a novel and innovative approach referred to herein as Advanced Realistic Rendering Technique (ART). The framework described herein allows the user to interact with CT scan data in both a high-quality mode for the deterministic algorithms (e.g., iso-surface, MIP, DVR) and in a lower-quality mode for stochastic AR²T. In the example described herein, the framework is written in C++ using Qt. In embodiments, the rendering runs primarily on a GPU and is implemented in OpenGL Shading Language (GLSL).

In this context, C++ serves as the core language for implementing the framework's logic, data structures, and algorithms. Qt is an open-source application framework and widget toolkit for creating graphical user interfaces (GUIs) and cross-platform applications. It provides a comprehensive set of C++ libraries, development tools, and APIs for designing, building, and deploying applications on various platforms. In this framework, Qt is used to create the user interface, handle user input, and manage application resources, such as windows, dialogs, and menus. OpenGL Shading Language (GLSL) is a high-level shading language used to program shaders in the OpenGL graphics rendering pipeline. Shaders are small programs that run on the GPU and are responsible for processing the geometry data and producing the final rendered images. GLSL allows developers to write custom shaders, providing great flexibility and control over the rendering process. In this framework, GLSL is used to implement the rendering algorithms, such as direct volume rendering, ray casting, or iso-surface rendering, that visualize the 3D volumes or other graphics data. The framework relies primarily on the GPU for rendering, taking advantage of the GPU's parallel processing capabilities to achieve high-performance, real-time visualization. By using GLSL and OpenGL, the framework can offload the computationally intensive rendering tasks to the GPU, freeing up the CPU for other tasks, such as user input processing, data manipulation, and application logic. This combination of technologies allows the framework to deliver high-performance rendering and visualization of 3D volumes, enabling real-time interaction and exploration by the user.

Implementations of the most popular rendering techniques for biomedical volumetric data-iso-surface, MIP, and DVR—are discussed herein as a basis of comparison for the described methods and approaches. In one example, depicted in FIG. 7, a DVR model with enriched with local and global illumination, applying various approaches in an attempt to improve realism. Specifically, from left to right, there is: local illumination; local and global illumination (with light distributed along a line); local and global illumination (with light distributed within a cone); and local and global illumination with translucency (with light distributed within a cone). For all techniques in this example, Phong local illumination was used. Although such techniques can improve realism by introducing deep shadows, they are not suitable for the visualization of biomedical volumes, because they hide information in the shadowed areas and do not actually increase the level of detail in the images. Indeed, clinicians prefer DVR with local illumination only, to avoid obscuring volumes and/or areas.

There are two modalities of AR²T visualization described herein: pure AR²T and mixed DVR-AR²T. When pure AR²T is active, the interactivity is achieved by the execution of just one iteration of the algorithm. When the interaction is finished (e.g., when the mouse button is released), a number of iterations, e.g., 10 iterations, of AR²T are executed. To improve the quality, Gaussian blur filter may be applied during the interactions, so the overall image is more understandable. On request, the iterative algorithm improves the quality until the user stops the process or convergence is achieved. In the mixed modality, the interactions are in DVR, and the AR²T runs on request. When the interaction restarts, the visualization automatically switches to DVR.

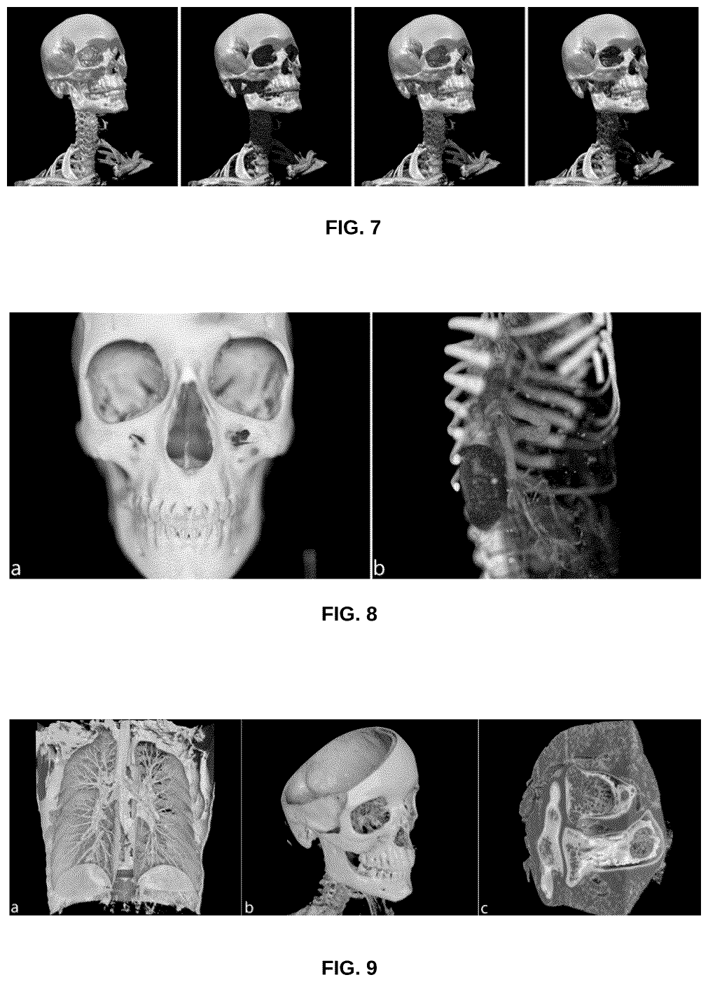

AR²T may be applied to analytically generated volumes in a manner akin to Monte Carlo Path Tracing (MCPT). In some cases, the model may include advanced camera settings (e.g., aperture, focal distance, see FIG. 8) and may support an unlimited number of light sources of any shape. For practical reasons, the number of ray scatters may be limited to 10 (in experiments, there was no evident improvement in realism for a larger number of scatters).

As noted above, GLSL (OpenGL Shading Language) is a high-level shading language used to program shaders in the OpenGL graphics API. Shaders are small programs that run on the GPU and are responsible for different stages of the graphics pipeline, such as vertex processing, geometry processing, and fragment processing. By using GLSL to write custom shaders, hardware-independent volume rendering techniques were created for 3D volumes acquired by computed tomography (CT).

In embodiments, the 3D CT volume is loaded into OpenGL as a 3D texture. The texture stores the intensity values for each voxel in the volume. A transfer function is defined to map the intensity values in the CT volume to color and opacity values for rendering. This can be done by creating a 1D or 2D texture that represents the transfer function, or by specifying the transfer function directly in the GLSL shader code. GLSL shaders may be used to perform the volume rendering process. This typically involves writing a vertex shader and a fragment shader.

The vertex shader is responsible for transforming the vertices of the proxy geometry (e.g., cubes) that enclose the volume. It computes the texture coordinates and passes them to the fragment shader. The fragment shader performs the core of the volume rendering process. It uses the texture coordinates passed from the vertex shader to sample the 3D texture containing the CT volume data. Then, it applies the transfer function to obtain color and opacity values for each sample. The fragment shader is also responsible for implementing the ray casting, sampling, and volume integration steps, as well as any lighting or shading models. In the rendering process, the proxy geometry is drawn using OpenGL, with the custom shaders bound to the rendering pipeline. This process computes the final color and opacity values for each pixel in the output image, based on the 3D CT volume data and the transfer function.

As noted above, the transfer function is used in volume rendering for mapping voxel intensity values in a 3D volume acquired by computed tomography (CT) to color and opacity values. The transfer function plays an important role in revealing the underlying structures and features within the volume data by highlighting regions of interest and providing visual cues for interpreting the data. There are several ways to define a transfer function, and the choice depends on the specific application requirements, data characteristics, and desired visualization output. In one important aspect, interactive methods may be used to allow users to define transfer functions based on their specific visualization goals. This can involve using graphical interfaces to manipulate color and opacity values directly or specifying semantic labels for different intensity ranges (e.g., bone, soft tissue, air). Thus, interactive transfer function design can provide more control and flexibility.

GLSL does not support recursive function calls, which poses a challenge when implementing techniques like Monte Carlo Path Tracing in the context of rendering 3D volumes acquired by CT, because MCPT is an inherently recursive algorithm in which rays bounce off surfaces or scatter within the volume and spawn additional rays. Another challenge is that GLSL does not provide for random number generation.

As the GLSL memory model does not provide for recursive function calls, which are essential for MCPT-type approaches, recursion was simulated by exploiting the multiple render targets (MRTs) feature of the GPU. This feature allows the rendering pipeline to render images to multiple render target textures at once. In embodiments, the information needed after every scatter of a ray is the resulting color, the position where the scatter occurred, and the direction in which the ray scatters. Therefore, three target textures may be used for each rendering step. In embodiments, two frame buffers may be used in a “ping pong” blending technique to enable the reading of textures filled on the previous step. Thus, in the first step, the ray origin and direction are calculated according to the camera properties and position. In the subsequent steps, the ray origin and direction are read from the corresponding textures.

In any ray scattering iteration, three situations are possible: (1) The ray does not hit the volume or the light source. In this case, a zero-length vector is saved to a direction render target to indicate that the ray scattering finishes here (i.e., the ray is no longer an active, scattering ray), and the resulting color components are set to zeros. In embodiments, for ulterior speed up, and considering that the usual background for biomedical visualization is black, the system may not model the Cornel box outside the volume. (2) The ray hits the light source. Then, the resulting color, accumulated until this moment, is attenuated by the light's color, and, again, the ray scattering finishes here. (3) The volume is hit. The scattering continues, until the ray encounters any of the stopping conditions, or the scatter number limit is achieved, in which case the resulting color components are set to zeros.

To provide the uniformly distributed random numbers for the fragment stage of the OpenGL pipeline, in embodiments, a pool of 50 additional two-dimensional textures of viewport size may be generated and filled with uniformly distributed random numbers generated with std::uniform_int_distribution in C++. In each step, four textures may be randomly selected from the pool to provide random numbers: two for advanced Woodcock tracking, one for scattering, and one for sampling direction. After a number of iterations, e.g., 100, the pool of random numbers may be regenerated to maintain the quality of the random number pool. On Intel(R) Core(TM) i5-7600K CPU@3.80 GHz, the generation of the pool took ˜1600 ms, for viewport size 1727×822, and it occupied ˜270 Mb of RAM.

In embodiments, Advanced Woodcock Tracking may be used for volume sampling. When the maximum volume density is much larger than the typical density in the volume, the Woodcock tracking can be improved by breaking the original volume into sub-volumes, each having a small density variation. For this aim, every time the transfer function changes, a voxel grid may be constructed that has the local maxima of the density in its nodes. Then, the voxel grid is applied to Woodcock tracking. This results in up to a 5× speed-up respect to the basic implementation. For example, on NVIDIA Geforce GTX 1060, the voxelization process, implemented in GLSL and executed on a fragment stage, took up to 500 ms for a voxel grid node size s=4, depending on the volume size. The additional memory needed for the voxel grid storage was 1/s³ of the original volume size.

In the context of MCPT-type rendering of 3D volumes acquired by computed tomography (CT), phase functions play an important role in simulating light interaction with different types of biological media. They are used to model the appearance of surfaces, as well as the scattering and absorption properties of participating media, like tissues or fluids, inside the volume. In particular embodiments of AR²T, four types of phase functions may be used: Lambertian, metal, dielectric, and isotropic.

A Lambertian phase function models a perfectly diffuse surface, where light is scattered equally in all directions. In the context of CT volumes, Lambertian reflection can be used to approximate the behavior of light interacting with certain types of tissues or surfaces. It is a simple and efficient model for simulating diffuse reflection and can help to provide a basic understanding of the overall structure and shape of the volume.

A metal (i.e., conductor) phase function exhibits specular reflection, where light is reflected in a mirror-like manner. While metallic materials are not common in biological tissues, they might appear in medical implants or prosthetics within a CT scan. Using a metal phase function, e.g., based on the Cook-Torrance model or GGX model, allows for simulating the appearance of these metal components in the CT volume, thereby enhancing the visualization's realism.

A dielectric (i.e., Fresnel) phase function may be used for dielectric materials, like glass or water, which exhibit both reflection and refraction. In the context of CT volumes, dielectric materials can be used to simulate the appearance of interfaces between different types of tissues or fluids, where light is partially reflected and partially transmitted. By using a Fresnel-based, bidirectional reflectance distribution function (BRDF) or a combination of reflection and transmission models, realistic visualizations of such interfaces can be generated in the CT volume.

The isotropic phase function may be used to describe the scattering behavior of light within a participating medium (e.g., tissue, fluid) in a volume. An isotropic phase function implies that light is scattered equally in all directions. This is a simple model that can be used to approximate the behavior of light scattering in certain types of homogeneous tissues or fluids in a CT volume. More advanced phase functions, such as the Henyey-Greenstein model, can be used to simulate anisotropic scattering, where light scattering depends on the angle between the incoming and outgoing directions.

These phase functions can be incorporated into the AR²T algorithm to simulate the behavior of light as it interacts with different types of media in the 3D CT volume. By combining these models with a proper transfer function, the AR²T algorithm can generate realistic visualizations of the volume data, helping medical professionals better understand the underlying structures and properties of the scanned object.

In disclosed embodiments, each time a scattering ray hits a volume voxel, a phase function is chosen and applied based on the density of the voxel. For example, if the density is less than some threshold to, it causes dielectric scatter; when it is higher than some threshold t₁, it causes metal scatter; otherwise, it is randomly whether to sample toward the light sources or to pick a direction according to the voxel reflection (e.g., using a mixture probability density function). When it is decided to sample according to the hit voxel direction, and the density of voxel a is in interval (t₀, t₁), a choice is made between surface and volumetric scattering. In embodiments, there is a switching between Lambertian and isotropic phase functions, in some cases based not only on the voxel density but also on the local gradient. Thus, Lambertian may be chosen with the following probability:

$$p = 1 - α ( \vec{v} ) \cdot ( 1 - {e}^{- s \cdot m ( \vec{v} )} ) , \qquad ( 1 )$$

where a(\vec{v}) is the voxel density (or opacity), m(\vec{v}) is the normalized gradient magnitude, and s is the hybrid scattering factor.

When the first iteration of AR²T is completed, the result contained in the color texture is blit into the output rendering frame buffer to be immediately displayed. Moreover, it is saved locally to be summed with the results of the next iterations. In subsequent iterations, the accumulated result is saved into the local buffer, and then the average (i.e., the sum divided by the iterations number) is blit into the output frame buffer and displayed.

In embodiments, mean square displacement (MSD) between the iterations may be used as a convergence criterion. In such a case, after each iteration, the square displacement between the current and the previous pixel color components is calculated directly on a fragment stage. When MSD is less than, e.g., ∈(=5·10⁻⁷, the iterations are stopped and the method is considered converged (see Figure B5). In experiments, convergence was achieved within 800 iterations for all images, and it took up to 100 seconds.

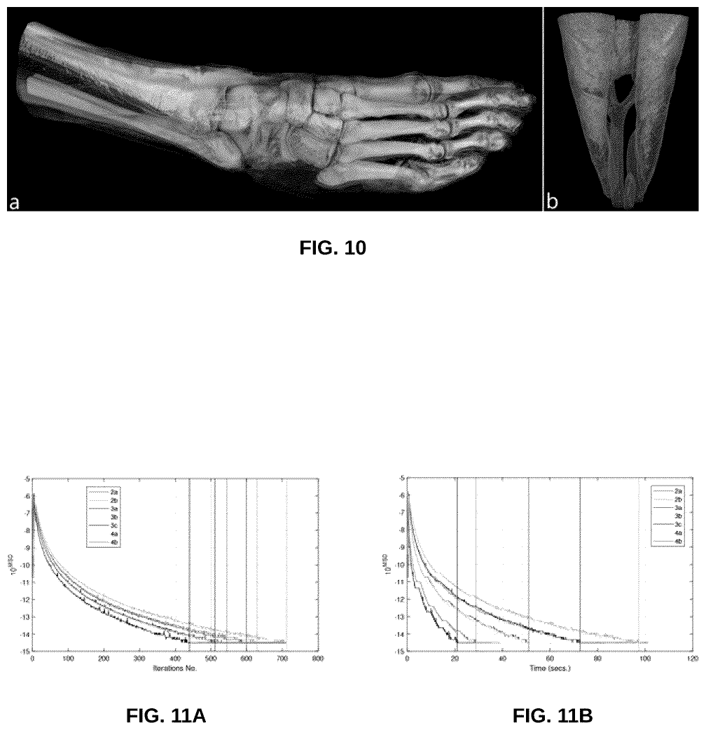

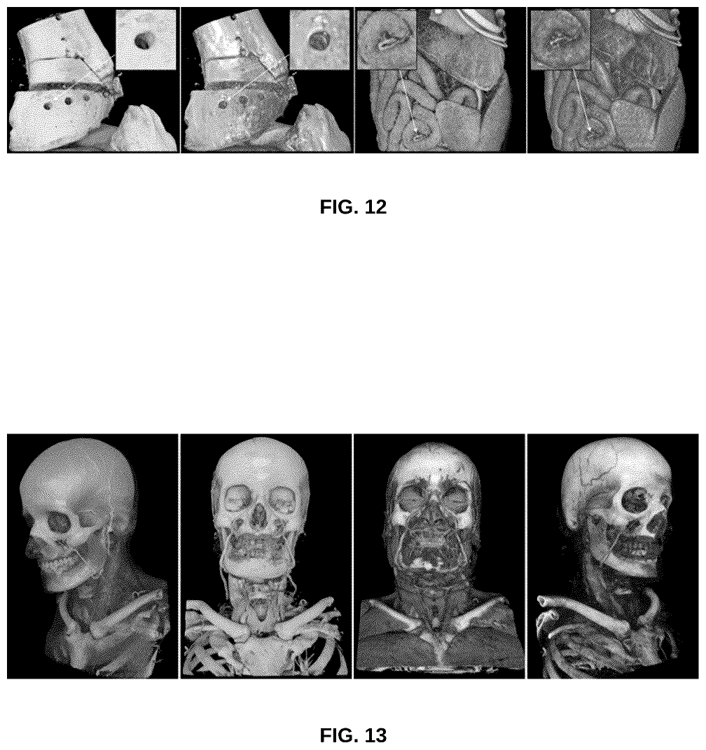

FIGS. 8-10 and 13 depict results of the research described herein, which included the development of the novel and innovative advanced realistic rendering technique (AR²T) (see, e.g., FIGS. 8-10, and 13) implemented in a practical framework that allows user interaction with the data in real time and provides for comparison of different rendering techniques directly, i.e., using the same view/light position and transfer functions. FIGS. 8-10 demonstrate the use of advanced camera settings (FIG. 8) and imaging for hard and soft tissues (FIG. 9) and translucency (FIG. 10). In FIG. 12, for example, some of the elements that become considerably more apparent with the AR²T, in comparison to DVR, are highlighted.

In the experiments, Cone-Beam Computed Tomography (CBCT) was used to acquire volumes using a CT Medical Imaging Platform (except for volumes obtained from Manix, see FIG. 13). All data sets are anonymous, post mortem, animals, or publicly available. The images presented herein and discussed above (except for FIG. 7) were generated with a single spherical light source, placed right in front of the volume. However, the models discussed herein are not limited to a single light source and may use numerous light sources in various positions.

FIGS. 11A-11B depict convergence plots in which vertical lines (2a-4b) indicate the number of iterations needed for convergence (left) and the convergence time in seconds (right). All images were generated on NVIDIA Geforce GTX 1060 6Gb, Intel(R) Core(TM) i5-7600K CPU@3.80 GHz RAM 16Gb, viewport size 1727×822. All data sets are encoded in 16-bit format.

FIG. 13 depicts publicly available Manix data set rendered with different AR²T settings.

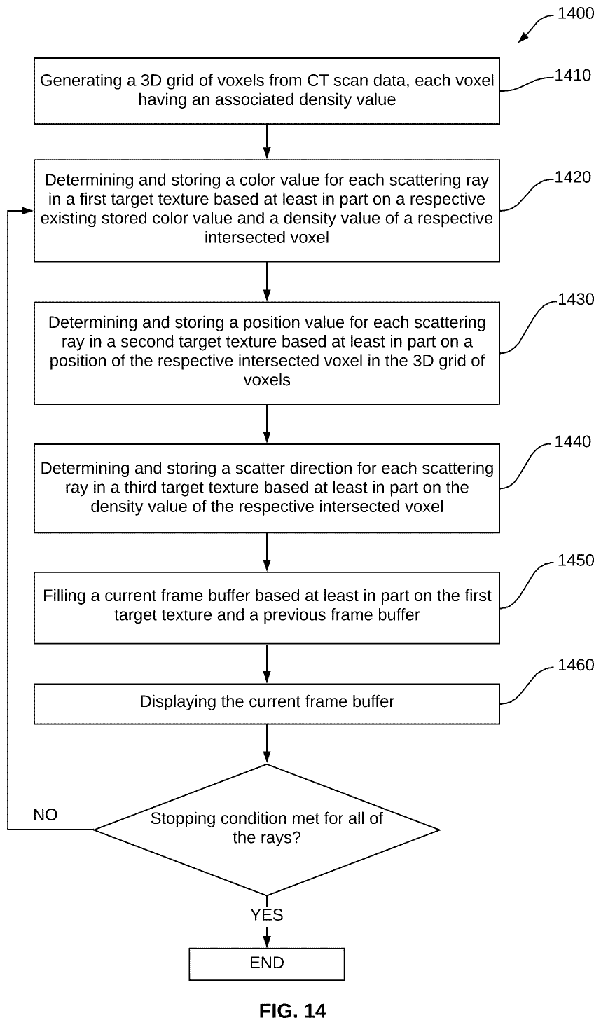

FIG. 14 is a flowchart of a method 1400 for rendering three-dimensional (3D) volumes from scan data acquired by computed tomography (CT). The method includes generating a 3D grid of voxels from CT scan data, each voxel having an associated density value (1410). The method further includes iteratively tracing a plurality of rays originating at a camera position by performing the following. A color value is determined and stored for each scattering ray in a first target texture based at least in part on a respective existing stored color value and a density value of a respective intersected voxel (1420). A position value is determined and stored for each scattering ray in a second target texture based at least in part on a position of the respective intersected voxel in the 3D grid of voxels (1430). A scatter direction is determined and stored for each scattering ray in a third target texture based at least in part on the density value of the respective intersected voxel (1440). A current frame buffer is filled based at least in part on the first target texture and a previous frame buffer (1450). The current frame buffer is displayed (1460). The method further includes repeating (1420-1460) until a stopping condition is met for all of the rays of the plurality of rays (1470).

In embodiments, the method may further include determining an initial origin and direction for each ray of the plurality of rays based at least in part on the camera position. In an iteration, when a scattering ray does not intersect a voxel or a light source, a stopping condition of the scattering ray may be met and a zero-length vector may be stored in the third target texture. When a scattering ray intersects a light source, a stopping condition of the scattering ray may be met and the respective existing stored color value may be attenuated based at least in part on the color of the intersected light source. When a scattering ray exceeds a scatter number limit, a stopping condition of the scattering ray may be met and the respective existing stored color value may be set to zero.

In embodiments, the first target texture, the second target texture, and the third target texture, may each be two-dimensional textures of viewport size, wherein the filling of the current frame buffer based at least in part on the first target texture and the previous frame buffer comprises summing corresponding values of the first target texture and the previous frame buffer and dividing by the number of iterations.

As explained above, a voxelization method can be applied to biomedical volume rendering optimization for empty space skipping, optimized maximum intensity calculation, and advanced Woodcock tracking. Empirical results indicate that the voxelization technique can increase the performance of Direct Volume Rendering (DVR) by up to 10 times, Monte Carlo Path Tracing (MCPT) by 5 times, and Maximum Intensity Projection (MIP) by 2 times of the original velocity.

The inventors have investigated the influence of a 3D fractal dimension of the rendered volumes to the rendering speed and the optimal super voxel size, used in voxelization process, to provide the best performance of DVR, MCPT, and MIP, using voxelization. 3D fractal dimensions are calculated for five common transfer functions applied to the Cone-Beam Computed Tomography (CBCT) scans of exotic animals and human extremities (post mortem). The volumes rendered with similar transfer functions have comparable 3D fractal dimension and, moreover, there is a statistically significant relationship between the DVR and AR²T speed and the 3D fractal dimension. Furthermore, the structures with higher 3D fractal dimension require the smaller super voxel sizes for empty space skipping, meanwhile, optimized maximum intensity calculation and advanced Woodcock tracking are 3D fractal dimension independent. Thus, structural complexity is advantageous in 3D rendering optimization for biomedical volumes.

As discussed above, 3D rendering of biomedical volumes can be used to illustrate the diagnosis to patients, train inexperienced clinicians, or facilitate surgery planning for experts. The most widely used rendering techniques are Maximum Intensity Projection (MIP) and Direct Volume Rendering (DVR). Recently, the Monte Carlo path tracing (MCPT) rendering technique, which is based on the physical transport of light, was introduced. Depending on the algorithm, level of detail, volume size, and transfer function, rendering can be quite slow.

In the foregoing, the inventors introduced a voxelization method for biomedical volume rendering optimization. An advantage of the methods, besides the fast structure construction and traversal, is that they are applicable to MIP, DVR and MCPT rendering techniques, thereby demonstrating multitarget optimization. Thus, one particular structure—a voxel grid—can be used for empty space skipping, optimized maximum intensity calculation and advanced Woodcock tracking. The voxelization technique provided notable performance improvements-accelerating DVR by up to 10 times, MCPT by 5 times, and MIP by 2 times of the original velocity.

Typically, the rendering algorithm's performance, supported by acceleration structures, depends on specific structure parameters. These parameters are commonly set to fixed values determined empirically. While these fixed parameters may not always be optimal, conventional approaches have not explored the connection between biomedical volume properties and the optimal parameters for rendering acceleration.

Disclosed embodiments focus on the 3D Fractal Dimension (3DFD) of Cone-Beam Computed Tomography (CBCT) volumes. The discussion below evaluates the dependence between the 3D fractal dimension and the rendering speed of biomedical volumes together with the optimal super voxel size for DVR, MCPT, and MIP. By virtue of the disclosed features, the rendering performance is at its best when voxelization is employed.

Fractal geometry has been used in various scientific fields, including biomedical imaging. The 3D fractal dimension's capability to characterize different states and predict changes in phenomena has been used in electrocardiogramall morphology measurement in the brain, examination of bone trabeculation, and detection of breast cancer. To assess the complex structures of hard and soft tissues, researchers have used fractal geometry using the box counting technique. This technique, implemented through the voxelization process used for voxel grid construction, provides a quantitative measure of the structural complexity present in CBCT volumes. The discussion below provides practical insights into the on-the-fly calculation of the 3D fractal dimension and its application in guiding the choice of optimal super voxel size for enhanced DVR performance.

As explained in the foregoing, disclosed embodiments provide a biomedical imaging platform that supports various 3D rendering techniques: Maximum Intensity Projection (MIP), Direct Volume Rendering (DVR), and Advanced Realistic Rendering Technique (AR²T)—the technique, based on the Monte Carlo Path Tracing. Each of these rendering techniques uses a voxel grid as a supportive structure for performance improvement.

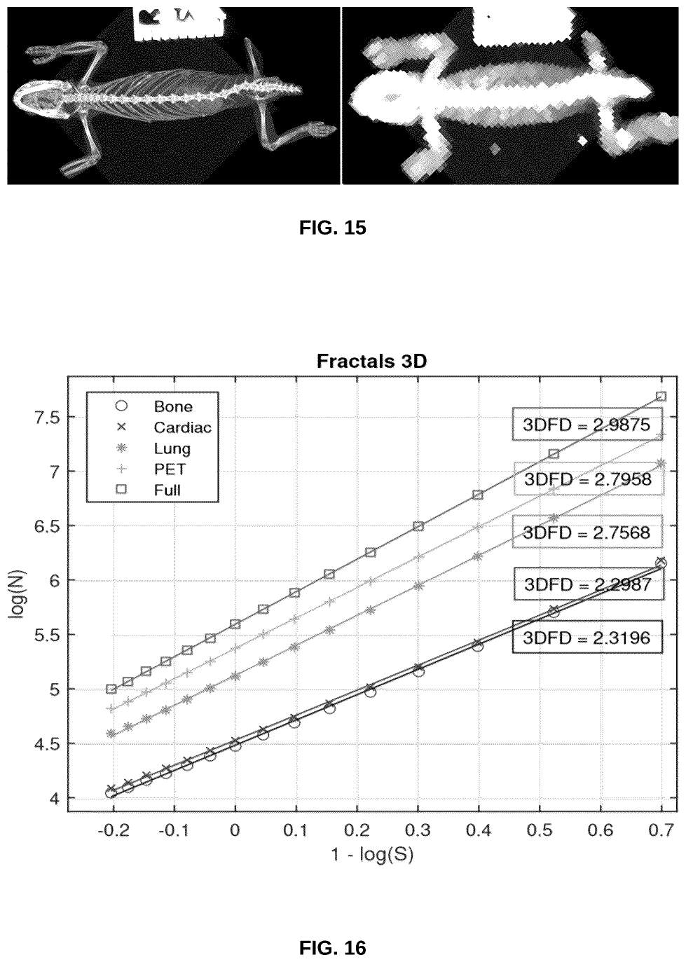

Voxelization is the process of construction of a voxel grid. In this process, the adjacent voxels of the original volume are combined to form a super voxel-a 3D cube of a certain size. The set of super voxels forms a voxel grid. FIG. 15 shows the voxelization of cone-beam computed tomography (CT) volumetric data from imaging a chameleon, showing an original volume rendered using Maximum Intensity Projection with a full range transfer function (left); and a voxel grid rendered using Maximum Intensity Projection with a super voxel size of 16 (right).

A super voxel may be constructed by finding the maximum value of transparency (or density) of all voxels that fall within the super voxel. Doing so, the voxel grid can be applied in DVR for empty space skipping, considering that the voxels whose density is zero (or lower than a certain threshold) do not normally contribute to the result of a volume rendering procedure and therefore should not be sampled. If the density of the super voxel is less than a certain threshold, all the voxels that contributed to the construction of this super voxel in the voxelization phase can be skipped without sampling. For MIP, the idea of optimizing maximum intensity calculation is similar to empty space skipping. One difference is that the density of the super voxel is compared to the current maximum intensity value, rather than to a constant threshold. The constructed voxel grid can be used to implement advanced Woodcock Tracking, thereby improving the performance of the AR²T.

Fractal dimension (FD) may be used to quantify the complexity of a geometric shape or pattern. Fractals are self-repeating patterns that exhibit similar structures at different scales. The fractal dimension characterizes the intricate and irregular shapes of fractals.

The box counting method may be used to quantify the 3D fractal dimension, which describes how the number of cubes needed to cover a fractal pattern scales with the size of the cubes. Analytically, the relationship between the number of cubes containing a volume and the scale can be expressed as:

$$N ( S ) = C \cdot {S}^{- 3 DFD} , \qquad ( 1 )$$

where S is the size of the cubes, N(S) is the number of cubes of size S needed to cover the fractal pattern, C is a constant of proportionality, and 3DFD is the fractal dimension. In logarithmic form, it can be presented as:

$$l o g ( N ( S ) ) = - 3 DFD \cdot log ( S ) + log ( C ) . \qquad ( 2 )$$

As shown in FIG. 16, a linear regression on log (N(S)) and log(S) may be used to estimate the 3D fractal dimension. This example shows fractals for super voxel size 2 to 16 and their linear approximation of a hedgehog cone-beam computed tomography (CBCT) calculated for: bone, cardiac, lung, PET, and full range transfer functions.

Thus, 3D fractal dimension of the biomedical volume can be calculated as follows: for every super voxel size S the voxel grid is constructed; the total number N of the super voxels with non-zero transparency is calculated; and the plot log/log represents the dependency of Non S. The linear approximation for log/log plots is calculated by minimizing the distance between the points and the line. This can be done using, e.g., MATLAB polyfit function of degree 1.

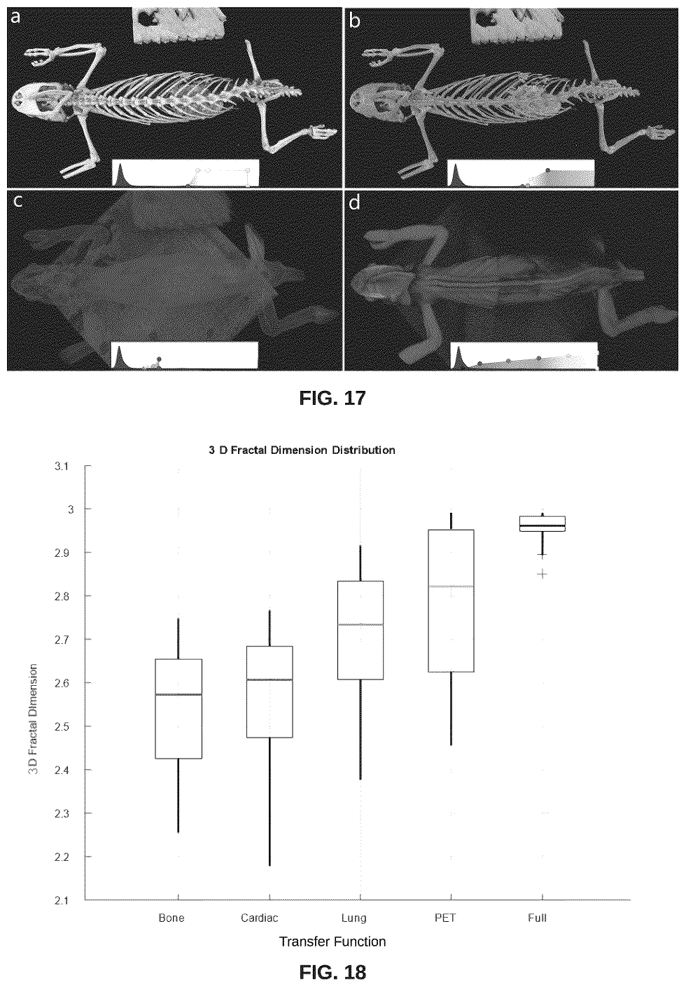

FIG. 17 shows a cone-beam computed tomography (CBCT) of a chameleon rendered using AR²T with specific transfer functions for optimal super voxel size evaluation by the 3D fractal dimension. Four transfer functions were applied: bone, cardiac, lung, and positron emission tomography (PET), to the CBCT acquisitions of exotic animals and human extremities (post mortem) for the DVR and the AR²T (the latter having been used in FIG. 17). The full range transfer function is exclusively applied to the MIP rendering.

Rendering performance were measured for the volumes of the prone-positioned animals and human extremities, ensuring that the entire image occupies about 60-80% of the screen (viewport 1920×1080).

The transfer functions were sequentially applied to DVR, AR²T, and MIP (full range only). Rendering occurred in four positions-prone, supine, left and right literal recumbent-repeated three times for improved performance measurement reliability. The final performance was calculated as the mean value of all the measurements. Voxelization was performed for super voxel sizes ranging from 2 to 16.

After calculating the 3D fractal dimension for all volumes and transfer functions, the maximum performance achieved during volume rendering was identified. The super voxel size was determined as corresponding to the maximum rendering speed in frames per second. In cases where the best performance corresponded to more than one super voxel size, the upper integer bound (ceil) of the medium super voxel size.

Because scans from different anatomical districts of animals and humans were employed, the difference in optimal super voxel sizes between scans of exotic animals and human extremities were initially assessed. The independent t-test for normally distributed quantitative variables and the Mann-Whitney test for non-normally distributed quantitative variables were used. When significant effects were identified, the Cohen's d (for normal distribution) or the Cliff's delta (for non-normal distribution) were calculated as a measure of effect size. The distribution of values was tested using the Shapiro-Wilk test.

The objective was to explore the relationship between 3D fractal dimension, rendering speed, and super voxel size. To achieve this, the Spearman test was employed. If a relationship was detected for the optimal super voxel size, all 3D fractal dimension values were organized and the range was divided into K equal intervals. Otherwise, the entire interval (e.g., K=1) was considered. The inventors identified the optimal super voxel size corresponding to the maximum rendering speed for volumes whose complexity fell within the given interval. The inventors statistically described the optimal super voxel size variables for each interval as mean±standard deviation (SD) for normally distributed quantitative data and median with interquartile range (IQR) for non-normally distributed data. Similarly, the 3D fractal dimension variable was statistically described for each transfer function. The dependency of the rendering speed on 3D fractal dimension was represented by scatter plots.

These analyses were performed separately for each rendering technique using MATLAB Statistics and Machine Learning Toolbox R2021b Update 5. The significance level for all tests was set to 0.05 (p<0.05).

FIG. 18 is a plot of 3D fractal dimension ranges over a range of super voxel sizes for different types of transfer functions. The figure shows the median (50th percentile) as the line inside the box and the interquartile range (IQR) within the box, spanning from the 25th to the 75th percentile. The box length represents the middle 50% data spread, with whiskers extending to 1.5 times the IQR from quartiles. Outliers are denoted as (+). The figure suggests that the 3D fractal dimension of biomedical volumes with similar transfer functions is comparable

The inventors analyzed two groups of scans: exotic animals (28 scans) and human extremities (20 scans). The statistical analysis of the optimal super voxel sizes did not reveal any significant differences between the scans of exotic animals and human extremities for any of the rendering techniques. Consequently, all the scans were combined together for evaluation.

In calculating the 3D fractal dimension of the total of 240 volumes representations (48 scans per 5 transfer functions), it was determined that the 3D fractal dimension range stood between 2.1778 and 2.9912. Namely, Bone stood between 2.2556 and 2.7470, Cardiac between 2.1778 and 2.7661, Lung between 2.3761 and 2.9152, Pet between 2.4554 and 2.9912, and Full stood between 2.8513 and 2.9912.

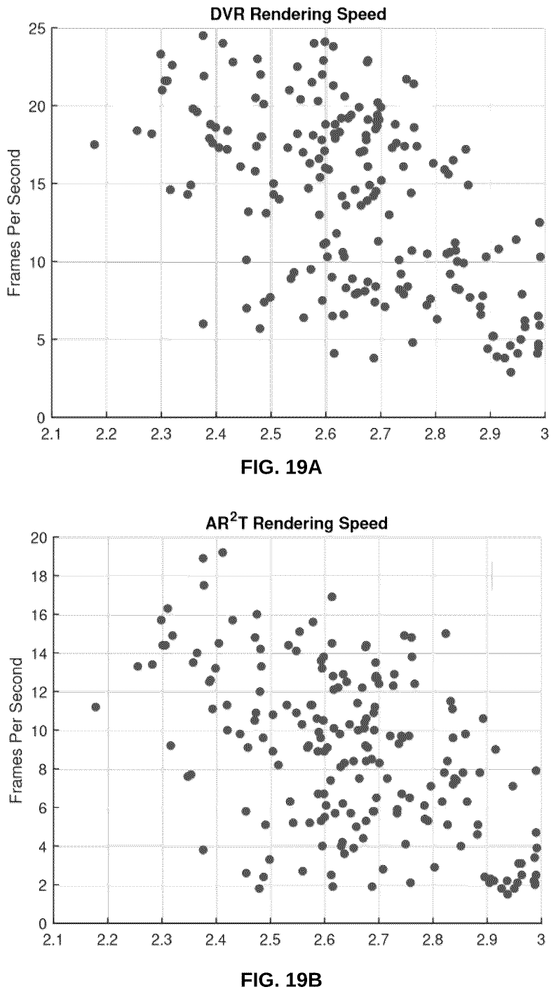

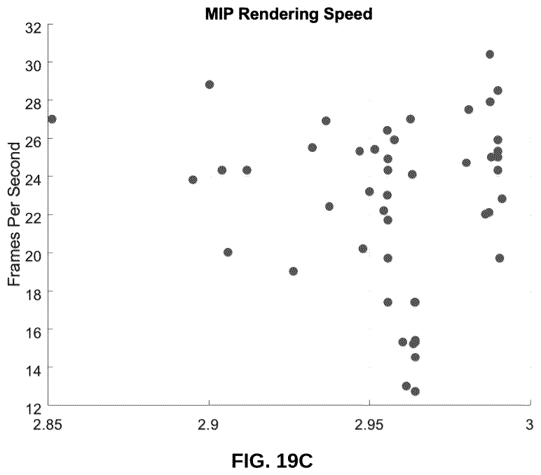

FIGS. 19A-C are scatter plots of rendering speed (i.e., the highest measured value) for DVR, AR²T, and MIP, on 3D fractal dimension which demonstrate a negative monotonic relationship for DVR and AR²T, but not for MIP. For DVR and AR²T, 192 variables were used (48 scans per 4 transfer functions). For MIP, 48 variables were used.

The statistical analysis of the maximum rendering speed (measured for super voxel size from 2 to 16) and 3D fractal dimension indicated a statistically significant negative monotonic relationship for DVR (pairwise linear correlation ρ=−0.511161, p-value=0) and AR²T (p=−0.472686, p-value=0), but not for MIP (p-value=0.8468).

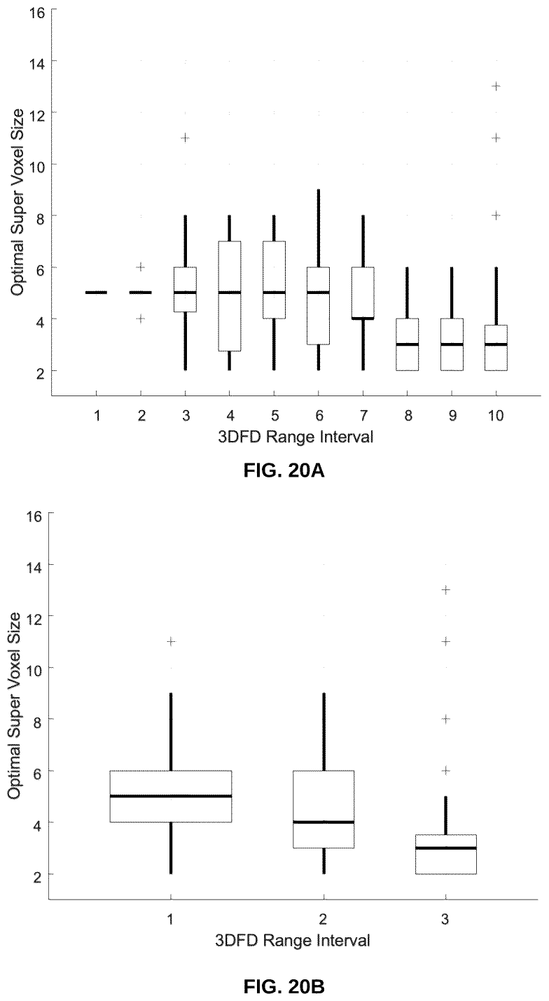

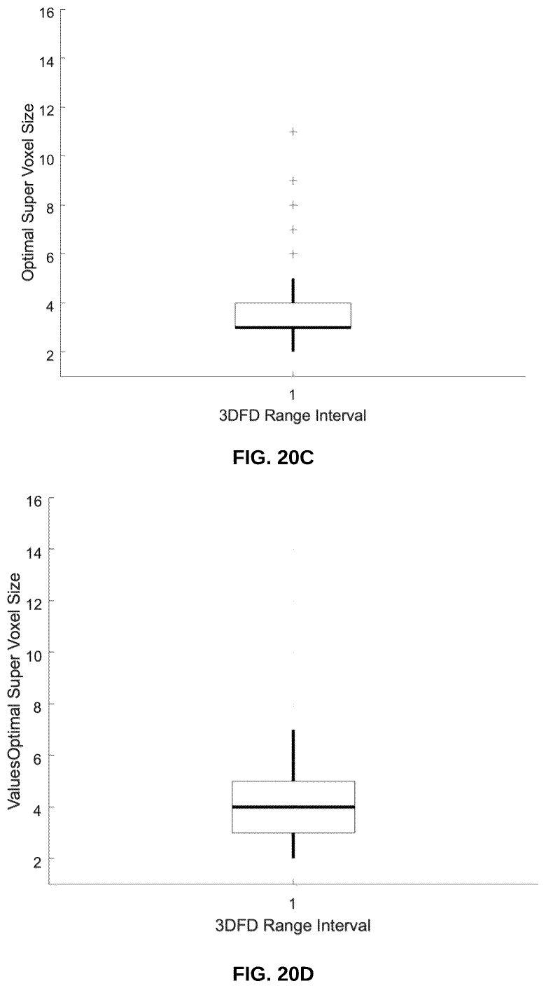

FIGS. 20A-D are plots of optimal super voxel size distribution for DVR (a-b), AR²T (c), and MIP (d). Subdivision of the 3D fractal dimension range on 10 equal intervals (a) indicates a non-linear dependency of the optimal super voxel size on the 3DFD and suggests a better subdivision on three intervals (b), where the first interval is a half of the entire range, and the second and the third intervals are the quarters.

The statistical analysis of optimal super voxel size and 3D fractal dimension indicated a statistically significant negative monotonic relationship for DVR (p=0.358652, p-value=0), while no statistically significant relationship for AR²T (p-value=0.8862) and MIP (p-value=0.1044) was detected. Accordingly, the inventors investigated the optimal 3DFD range subdivision for DVR. Initially, the inventors set intervals count K to 10. As shown in FIG. 20A, the monotonic negative relationship between the 3D fractal dimension and the optimal super voxel size for DVR was not linear. FIG. 20A analysis suggested the best practical subdivision of the range of 3D fractal dimension into three intervals: a half and two quarters (namely, [2.1778,2.5845)₁, [2.5845,2.7878)₂, [2.7878,2.9912]₃). To confirm the correctness of this subdivision, Spearman test was repeated on each interval, and it indicated no statistically significant relationship of optimal super voxel size and 3DFD on these intervals (p-value)=0.9356, p-value2=0.0908, p-value3=0.5036). The medium value of the first half of the 3D fractal dimension interval was 5, meanwhile, the second and third quarters required 4 and 3, respectively (see FIG. 20B). For AR²T, the optimal super voxel size did not depend on the 3D fractal dimension and, consequently, was 3 for the entire range (see FIG. 20C). Finally, the full range transfer function produced the structures with the highest 3D fractal dimension, and the optimal super voxel size for the MIP was 4 (see FIG. 20D).

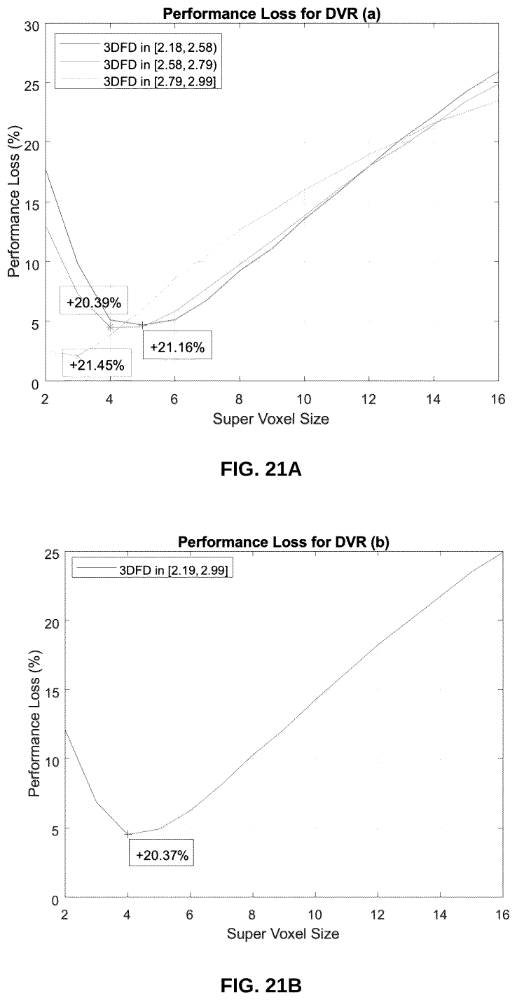

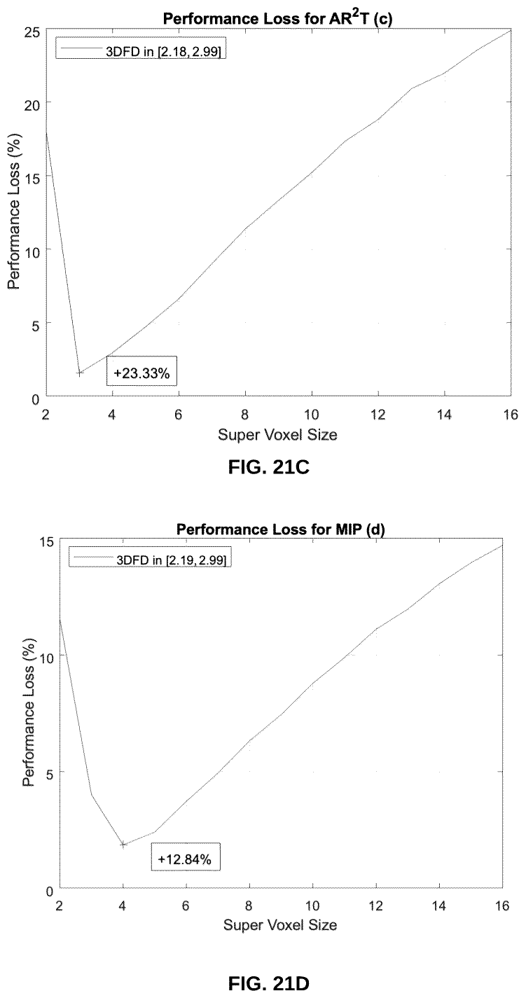

FIGS. 21A-D are plots of performance loss for DVR (a-b), AR²T (c), and MIP (d), calculated as the difference between the best performance and the performance, achieved using the optimal super voxel size found for the rendering algorithm and the given interval. The values in the boxes indicate the difference between the performance using the optimal super voxel size and the worst performance using super voxel size from 2 to 16.

To demonstrate the performance improvement achieved by applying the determined optimal super voxel sizes, the overall efficiency loss was calculated. Given the practical challenges of determining the true optimal super voxel size for each case, the efficiency loss represented the potential inefficiency introduced by the choice of the determined super voxel size and the true optimal super voxel size. Thus, the efficiency loss was estimated as the difference between the performance achieved using the optimal super voxel size found for the given rendering technique and interval, and the best performance achieved for the given case. These values were averaged to provide an overall measure of efficiency loss. Importantly, a lower efficiency loss indicated a better super voxel size choice. FIGS. 21A-D demonstrate that the lowest efficiency loss corresponds to the super voxel size found earlier (see FIGS. 20A-D).

The optimal selection of the super voxel size allowed for a gain of more than 20% in performance for DVR and AR²T, and 12% for MIP (see FIGS. 21A-D). This improvement was in contrast to the worst performance that could be achieved by the suboptimal choice of the super voxel size, which, in these experiments, ranged from 2 to 16.

Analyzing different anatomical districts of animals and humans, it was found that the range of the 3DFD for different transfer functions remained within the values 2 and 3. A 3D fractal dimension between these values typically indicates a complex and intricate geometric pattern, suggesting a high level of complexity and self-similarity at different scales. Fractals with dimensions in this range often exhibit intricate details, irregular shapes, and self-repeating patterns. The range between 2 and 3 also means that the fractals likely exhibit a blend of planar and volumetric characteristics. The tendency towards the lower end of the range (closer to 2) indicates that the fractals may have a more pronounced sheet-like or surface quality. The intricate patterns and self-similarity are likely expressed across surfaces rather than throughout a more solid volume. As the dimension approaches 3, indicating a simpler, more regular structure, fractal fills space in a more solid-like manner while maintaining its intricate features. As FIG. 18 demonstrates, the transfer functions representing most complex anatomical districts have higher 3D fractal dimension. This result perfectly respects the anatomical structure represented by different transfer functions on FIG. 17.

The distribution of the 3D fractal dimension (3DFD) values on FIG. 18 suggests that the 3D fractal dimension of the biomedical volumes for the similar transfer functions are comparable. Some ranges are quite wide, but this can be explained by the nature of the CBCT scans which have different physical properties than spiral CTs and are not HU-calibrated (i.e. not calibrated in terms of Hounsfield units).

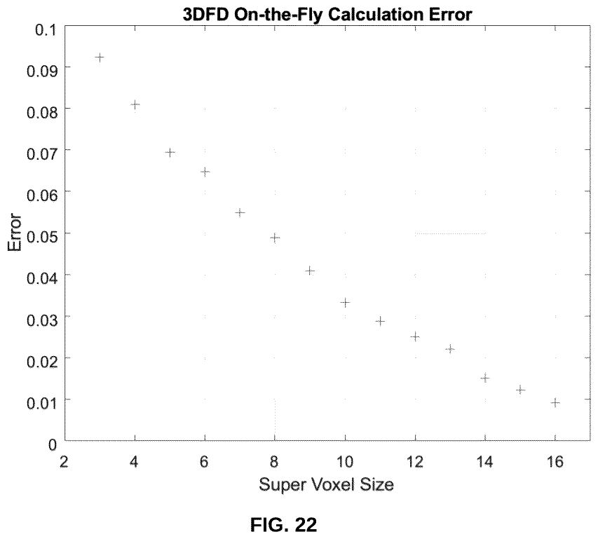

FIG. 22 shows the difference between the 3DFD (mean of 240 values) found using 15 fractals values versus the 3DFD (mean of 240 values) found on-the-fly using just 2 fractals values, for super voxel size 2 and 3-16. In the optimization implementation for DVR, where performance depends on the 3D fractal dimension, on-the-fly calculation of the fractal dimension provides optimal performance. This may involve calculating the number of non-empty 3D cubes for two super voxel sizes, e.g., 2 and 16. The experiments showed that these two values are enough for the approximate 3D fractal dimension calculation. The minimal resulting error between the 3DFD found using two values instead of 15 (as in experiments discussed above) is 0.009 (see FIG. 22) and demonstrates the practical feasibility of this approach. Knowing the 3D fractal dimension of the volume, it can be associated with one of three intervals and assigned the optimal super voxel size following FIG. 20B. The subdivision in three intervals and selecting the optimal super voxel size for each interval yielded approximately 1.2% speed-up compared to fixed super voxel size 4 (see FIG. 21B).

Statistical analysis confirmed the dependency between the 3D fractal dimension and the optimal super voxel size for DVR, but not for AR²T and MIP, aligning with earlier results discussed above. These findings suggested that DVR speed-up strongly depends on the transfer function. In contrast, acceleration for AR²T and MIP appeared stable, showing no significant dependency on the transfer function.

The results discussed above suggest that the 3D fractal dimension of biomedical volumes with similar transfer functions is comparable, and the transfer functions representing most complex anatomical districts have higher 3D fractal dimension. Moreover, a dependency was observed between the 3D fractal dimension and the optimal super voxel size for empty space skipping. Any improvement in rendering performance achieved through pre-calculating the optimal super voxel size for DVR-even a relatively small gain—can be valuable.

The analysis of optimal conditions for enhanced 3D rendering performance discussed above provides insights into the relationship between structural complexity and rendering optimization. Even incremental improvements in the efficiency of 3D rendering processes contribute to advancements in biomedical imaging and visualization.

Performing the techniques described herein for rendering 3D volumes acquired by computed tomography (CT) can be computationally expensive, as some aspects of the techniques involve simulating the complex light transport phenomena in a stochastic manner. To achieve acceptable rendering times and high-quality results, it is important to have capable computer hardware. A powerful graphics processing unit (GPU) is used, e.g., for efficient Monte Carlo Path Tracing, as the technique can be parallelized and benefits from the massive parallel processing capabilities of the GPU. In some embodiments, a high-end GPU may be used from manufacturers like NVIDIA or AMD, with support for the latest graphics APIs (e.g., OpenGL, Vulkan, DirectX) and shader languages (e.g., GLSL, HLSL). The GPU should have a large number of processing cores and high clock speeds to handle the complex calculations involved in the path tracing process. Adequate GPU memory is important to allow for storing the 3D CT volume data, intermediate render targets, and other resources for the Monte Carlo Path Tracing and AR²T techniques. The memory size should be sufficient to accommodate the input data, including any additional data needed for advanced features like acceleration structures, multiple bounce calculations, and/or volumetric scattering, as discussed above.

Although, in embodiments, the majority of the Monte Carlo Path Tracing and AR²T calculations are performed on the GPU, a modern and powerful CPU is still important for tasks such as loading and preprocessing the 3D CT volume data, managing the GPU resources, and handling user input. A multi-core CPU with high clock speeds from manufacturers like Intel or AMD may be used to provide sufficient processing power and performance. Sufficient system memory, e.g., random access memory (RAM), is needed to store the 3D CT volume data, transfer function, and other resources for the rendering processes described herein. The required amount of memory depends on, inter alia, the size of the input data and the complexity of the rendering process. Fast data storage, e.g., solid state storage, is important for storing and loading the 3D CT volume data, as well as any intermediate data generated during the rendering process. The storage capacity should be sufficient to accommodate the input data and any additional resources required for the rendering process.

The foregoing detailed description has presented various implementations of the devices and/or processes through the use of block diagrams, schematics, and illustrative examples. As such block diagrams, schematics, and examples include one or more functions and/or operations, it should be understood by those skilled in the art that each function and/or operation within these block diagrams, flowcharts, or examples can be implemented individually and/or collectively by employing a wide range of hardware, software, firmware, or any combination thereof. It should also be recognized by those skilled in the art that the methods or algorithms described herein may incorporate additional steps, may exclude some steps, and/or may execute steps in an order different from the one specified. The various implementations described above can be combined to create additional implementations.

These modifications and other changes can be made to the implementations in light of the above-detailed description. Generally, the terms used in the following claims should not be construed to limit the claims to the specific implementations disclosed in the specification and the claims. Instead, they should be interpreted to encompass all possible implementations, along with the full scope of equivalents to which such claims are entitled. Consequently, the claims are not limited by the disclosure but are intended to cover all possible implementations within their scope.

1. A method for rendering three-dimensional (3D) volumes from scan data acquired by computed tomography (CT), comprising:
applying a transfer function to a 3D grid of voxels generated from the scan data, each voxel having an associated intensity value, to determine a density value associated with each voxel;
generating a 3D grid of super voxels, each super voxel being formed from a plurality of adjacent voxels of the 3D grid of voxels, each super voxel having an associated density value;
performing an optimization using the 3D grid of super voxels, based at least in part on a defined super voxel size;
drawing a 3D volume based at least in part on the 3D grid of super voxels and the determined density associated with each super voxel.

2. The method of claim 1, wherein the associated density value of each super voxel is a maximum value of densities of said plurality of adjacent voxels forming each super voxel.

3. The method of claim 1, wherein said generating a 3D grid of super voxels comprises performing trilinear interpolation on the 3D grid of voxels.

4. The method of claim 1, wherein said drawing a 3D volume based at least in part on the 3D grid of super voxels comprises:
setting viewport dimensions of a fragment shader to a size of a volume slice (X×Y); and
drawing, for each volume slice of a total number of volume slices, Z, a quad that covers the entire viewport.

5. The method of claim 1, further comprising repeating said generating the 3D grid of super voxels whenever the transfer function is changed.

6. The method of claim 1, said performing an optimization comprises performing an enhanced empty space skipping optimization, the method comprising:
determining a maximum density value by comparing a first density value sampled at a first position along a ray and a second density value sampled at a second position along the ray, the second position being a distance D from the first position, where D is a first defined step size;
setting a step increment to a distance d, where d is a second defined step size, with d<D;
determining whether the maximum density value is greater than a defined threshold;
returning the density value sampled at the first position, if the maximum density value is greater than the defined threshold, otherwise setting the step increment to the first defined step size D;
advancing step-wise along the ray by the step increment; and
iteratively repeating said determining a maximum density value, said setting the step increment, said determining whether the maximum density value is greater than a defined threshold, said sampling, and said advancing, until an end of the ray is reached.

7. The method of claim 6, wherein D=d·s, where s is the defined super voxel size.

8. The method of claim 1, wherein said performing an optimization comprises performing an enhanced Maximum Intensity Projection, the method comprising:
(a) determining a local maximum density value by comparing a first density value sampled at a first position along a ray and a second density value sampled a second position along the ray, the second position being a distance D from the first position, where D is a first defined step size;
(b) determining whether the local maximum density value is greater than a ray maximum density value and if so: (i) returning the density value sampled at the first position, and (ii) resetting the ray maximum density value to a maximum of a current value of the ray maximum density value compared to the sampled density value at the first position;
(c) setting a step increment to a distance d, where d is a second defined step size, with d<D;
(d) determining whether the ray maximum density value is greater than or equal to the local maximum density value;
(e) setting the step increment to the first defined step size D if the ray maximum density value is greater than or equal to the local maximum density value;
(f) advancing step-wise along the ray by the step increment; and
iteratively repeating (a)-(f) until an end of the ray is reached.

9. The method of claim 8, wherein D=d·s, where s is the defined super voxel size.

10. The method of claim 1, wherein said performing an optimization comprises performing an enhanced Woodcock Tracking, the method comprising:
setting a current maximum density value equal to a ray maximum density value;
(a) determining a local maximum density value by comparing a first density value sampled at a first position along the ray and a second density value sampled at a second position along the ray, the second position being a distance D from the first position, where D is a first defined step size;
(b) setting a step increment (l) to the value of the first defined step size D;
(c) determining whether the local maximum density value is greater than a defined threshold and if so:
(i) returning the density value sampled at the first position,
(ii) determining whether the density value sampled at the first position divided by the current maximum density value is greater than a random value and, if so, halting processing of the ray,
(iii) setting the step increment (l) to the negative of the log of a random value divided by the local maximum density value,
(iv) determining whether the step increment (l) is greater than or equal to the first defined step size D and, if so, setting the step increment (l) to the negative of the log of a random value divided by the ray maximum density value and setting the current maximum density value equal to the ray maximum density value and, if not, setting the current maximum density value equal to the local maximum density value;
(d) advancing step-wise along the ray by the step increment (l); and
iteratively repeating (a)-(d) until an end of the ray is reached.

11. A method for rendering three-dimensional (3D) volumes from scan data acquired by computed tomography (CT), comprising:
generating a 3D grid of voxels from CT scan data, each voxel having an associated density value;
rendering an image by iteratively tracing a plurality of rays originating at a camera position, said rendering comprising:
(a) determining and storing a color value for each scattering ray in a first target texture based at least in part on a respective existing stored color value and a density value of a respective intersected voxel;
(b) determining and storing a position value for each scattering ray in a second target texture based at least in part on a position of the respective intersected voxel in the 3D grid of voxels;
(c) determining and storing a scatter direction for each scattering ray in a third target texture based at least in part on the density value of the respective intersected voxel;
(d) filling a current frame buffer based at least in part on the first target texture and a previous frame buffer; and
(e) displaying the current frame buffer; and
iteratively repeating (a)-(e) until a stopping condition is met for all of the rays of the plurality of rays.

12. The method of claim 11, further comprising determining an initial origin and direction for each ray of the plurality of rays based at least in part on the camera position.

13. The method of claim 11, wherein, in an iteration, when a scattering ray does not intersect a voxel or a light source, a stopping condition of the scattering ray is met and a zero-length vector is stored in the third target texture.

14. The method of claim 11, wherein, in an iteration, when a scattering ray intersects a light source, a stopping condition of the scattering ray is met and the respective existing stored color value is attenuated based at least in part on the color of the intersected light source.

15. The method of claim 11, wherein, in an iteration, when a scattering ray exceeds a scatter number limit, a stopping condition of the scattering ray is met and the respective existing stored color value is set to zero.

16. The method of claim 11, wherein the first target texture, the second target texture, and the third target texture, are each two-dimensional textures of viewport size.

17. The method of claim 11, wherein said filling the current frame buffer based at least in part on the first target texture and the previous frame buffer comprises summing corresponding values of the first target texture and the previous frame buffer and dividing by the number of iterations.

18. The method of claim 11, further comprising repeating said rendering one or more times to progressively display images of improved quality.

19. The method of claim 11, wherein an initial iteration of direct volume rendering (DVR) is performed before said rendering and said rendering is performed one or more times to progressively display images of improved quality.

20. The method of claim 11, wherein said determining and storing a scatter direction for each scattering ray comprises:
determining whether the density value of the respective intersected voxel is less than a first threshold, greater than a second threshold, or, otherwise, between the first threshold and the second threshold;
applying a dielectric phase function, if the density value of the respective intersected voxel is less than the first threshold;
applying a metallic phase function, if the density value of the respective intersected voxel is greater than the second threshold; and
randomly selecting between: (i) a scatter direction based on at least one light source direction, and (ii) a scatter direction based on voxel scattering, if the density value of the respective intersected voxel is between the first threshold and the second threshold.

21. The method of claim 20, further comprising, if the scatter direction based on voxel scattering is selected, randomly selecting between surface and volumetric scattering based at least in part on the density value of the respective intersected voxel and a local density gradient.

22. The method of claim 11, wherein said rendering an image further comprises:
generating a pool of two-dimensional textures;
filling the two-dimensional textures with uniformly distributed random numbers;
selecting, in each iteration of said iteratively repeating, randomly selecting one or more of the two-dimensional textures from the pool to use in one or more of: advanced Woodcock Tracking, scatter direction determination, and ray direction determination.

23. The method of claim 22, further comprising repeating said generating and said filling after a defined number of iterations.

24. The method of claim 1, wherein the super voxel size is determined based at least in part on a 3D fractal dimension of a 3D volume being rendered.

25. The method of claim 24, wherein the 3D fractal dimension is determined by:
generating a 3D grid of super voxels for each candidate super voxel size, s, in a defined set of super voxel sizes;
determining, for each candidate super voxel size, s, a quantity of super voxels having transparency greater than a defined threshold; and
performing a linear approximation on a log-log plot of candidate super voxel size versus the quantity of super voxels having transparency greater than the defined threshold, wherein the 3D fractal dimension is given by a slope of the linear approximation.

26. A system for rendering three-dimensional (3D) volumes from scan data acquired by computed tomography (CT), comprising:
a graphics processing unit (GPU) in communication with GPU memory;
a central processing unit (CPU) in communication with system memory, computer storage, and the GPU,
the computer storage storing code which is executed by the CPU and/or the GPU to perform a method for rendering three-dimensional (3D) volumes from scan data acquired by computed tomography (CT), comprising:
applying a transfer function to a 3D grid of voxels generated from the scan data, each voxel having an associated intensity value, to determine a density value associated with each voxel;
generating a 3D grid of super voxels, each super voxel being formed from a plurality of adjacent voxels of the 3D grid of voxels, each super voxel having an associated density value;
performing an optimization using the 3D grid of super voxels, based at least in part on a defined super voxel size;
drawing a 3D volume based at least in part on the 3D grid of super voxels and the determined density associated with each super voxel.

27. A computed tomography (CT) imaging system comprising the system of claim 26.

28. A computer-readable medium storing code for rendering three-dimensional (3D) volumes from scan data acquired by computed tomography (CT), wherein the code, when executed by a central processing unit (CPU) and/or a graphics processing unit (GPU), performs a method for rendering three-dimensional (3D) volumes from scan data acquired by computed tomography (CT), comprising:
applying a transfer function to a 3D grid of voxels generated from the scan data, each voxel having an associated intensity value, to determine a density value associated with each voxel;
generating a 3D grid of super voxels, each super voxel being formed from a plurality of adjacent voxels of the 3D grid of voxels, each super voxel having an associated density value;
performing an optimization using the 3D grid of super voxels, based at least in part on a defined super voxel size;
drawing a 3D volume based at least in part on the 3D grid of super voxels and the determined density associated with each super voxel.
